(19) United States
(12) Patent Application Publication
(10) Pub. No.: US 2014/0344747 A1
(43) Pub. Date: Nov. 20, 2014

(54) INPUT DEVICE AND IMAGE PROCESSING APPARATUS

(71) Applicant: Oki Data Corporation, Tokyo (JP)

(72) Inventor: Tsuyoshi ISHIGURE, Tokyo (JP)

(73) Assignee: Oki Data Corporation, Tokyo (JP)

(21) Appl. No.: 14/277,166

(22) Filed: May 14, 2014

(30) Foreign Application Priority Data
May 16, 2013 (JP) 2013-103801

(51) Int. Cl. G06F 3/0488; H04N 1/00

(52) U.S. Cl. CPC G06F 3/04886; H04N 1/00278; H04N 1/00129; H04N 1/00392; H04N 1/00384; H04N 2201/0094
USPC 715/773

(57) ABSTRACT

An input device is configured to display a software keyboard drawn by software and receive an input from a user, and includes: a touch panel unit configured to perform as a display to the user and receive an input by contact from the user; a layout information storage unit configured to store, as layout information, information about layout modes of keys included in the software keyboard displayed on the touch panel unit and display modes of the keys; a condition acceptance unit configured to accept a condition for selecting the layout information; and a software keyboard display instruction unit configured to read layout information that maintains the key layout mode while changing the display mode of some of the keys according to the condition, and to instruct the touch panel unit to display a software keyboard based on the read layout information.

### CROSS REFERENCE TO RELATED APPLICATIONS

This application claims priority based on 35 USC 119 from prior Japanese Patent Application No. 2013-103801 filed on May 16, 2013, entitled “INPUT DEVICE AND IMAGE PROCESSING APPARATUS”, the entire contents of which are incorporated herein by reference.

### BACKGROUND OF THE INVENTION

1. Field of the Invention

This disclosure relates to an input device and an image processing apparatus with the input device.

2. Description of Related Art

A conventional communication information terminal with a touch panel as an input device, such as a smartphone and a tablet computer, displays a software keyboard corresponding to a running application program. Given this conventional arrangement, an input device is thus known to that displays a software keyboard with key layouts which vary from application to application (see, for example, Japanese Patent Application Publication No. 2012-053887).

### SUMMARY OF THE INVENTION

However, the conventional input device has a problem in that at times it is inconvenient for a user who operates the input device.

An aspect of the invention is an input device configured to display a software keyboard drawn by software and to receive an input from a user. The input device includes: a touch panel unit configured to perform as a display to the user and to receive an input by contact from the user; a layout information storage unit configured to store, as layout information, information about layout modes of keys included in the software keyboard displayed on the touch panel unit and display modes of the keys; a condition acceptance unit configured to accept a condition for selecting the layout information; and a software keyboard display instruction unit configured to read layout information that maintains the key layout mode while changing the display mode of some of the keys according to the condition, and to instruct the touch panel unit to display a software keyboard based on the read layout information.

According to the above aspect, an improved convenience for users operating an input device can be realized.

### BRIEF DESCRIPTION OF THE DRAWINGS

FIG. 1 is a block diagram illustrating a configuration of an image processing apparatus according to a first embodiment of the invention.

FIG. 2 is a diagram illustrating a configuration of an operation panel unit according to the first embodiment of the invention.

FIG. 3 is a diagram illustrating layout information of a general-purpose software keyboard to type sentences when language information of the image processing apparatus is Japanese according to the first embodiment of the invention.

FIG. 4 is a diagram illustrating layout information in a state where a shift key is pressed on the general-purpose software keyboard to type sentences when the language information of the image processing apparatus is Japanese according to the first embodiment of the invention.

FIG. 5 is a diagram illustrating layout information of a dedicated software keyboard to type e-mail addresses when the language information of the image processing apparatus is Japanese according to the first embodiment of the invention.

FIG. 6 is a diagram illustrating layout information in a state where a shift key is pressed on the dedicated software keyboard to type e-mail addresses when the language information of the image processing apparatus is Japanese according to the first embodiment of the invention.

FIG. 7 is a diagram illustrating layout information of a dedicated software keyboard to type passwords when the language information of the image processing apparatus is Japanese according to the first embodiment of the invention.

FIG. 8 is a diagram illustrating layout information in a state where a shift key is pressed on the dedicated software keyboard to type passwords when the language information of the image processing apparatus is Japanese according to the first embodiment of the invention.

FIG. 9 is a diagram illustrating layout information of a general-purpose software keyboard to type sentences when the language information of the image processing apparatus is English according to the first embodiment of the invention.

FIG. 10 is a diagram illustrating layout information in a state where a shift key is pressed on the general-purpose software keyboard to type sentences when the language information of the image processing apparatus is English according to the first embodiment of the invention.

FIGS. 11A to 11D are first diagrams illustrating an example of a software keyboard according to the first embodiment of the invention.

FIGS. 12E to 12H are second diagrams illustrating an example of a software keyboard according to the first embodiment of the invention.

FIG. 13 is a table illustrating conditions of use of layout information of the software keyboard according to the first embodiment of the invention.

FIG. 14 is a table illustrating a relation between a delete key and the conditions of use of the layout information of the software keyboard according to the first embodiment of the invention.

FIG. 15 is a flowchart illustrating the processing operations in displaying the software keyboard according to the first embodiment of the invention.

FIG. 16 is a diagram illustrating a scan menu displayed on a display unit according to the first embodiment of the invention.

FIG. 17 is a first diagram illustrating a scan to Email setting screen displayed on the display unit according to the first embodiment of the invention.

FIG. 18 is a diagram illustrating a destination setting screen displayed on the display unit according to the first embodiment of the invention.

FIG. 19 is a second diagram illustrating the scan to Email setting screen displayed on the display unit according to the first embodiment of the invention.

FIG. 20 is a third diagram illustrating the scan to Email setting screen displayed on the display unit according to the first embodiment of the invention.

FIG. 21 is a diagram illustrating an error screen displayed on the display unit according to the first embodiment of the invention.

FIG. 22 is a flowchart illustrating the operations of a scan to Email process according to the first embodiment of the invention.

FIG. 23 is a block diagram illustrating a configuration of an image processing apparatus according to a second embodiment of the invention.

FIG. 24 is a diagram illustrating layout information of a general-purpose software keyboard to type sentences when the language information of the image processing apparatus is Japanese according to the second embodiment of the invention.

FIG. 25 is a flowchart illustrating the processing operations in displaying a software keyboard according to the second embodiment of the invention.

FIG. 26 is a diagram illustrating an example of the software keyboard according to the second embodiment of the invention.

FIG. 27 is a flowchart illustrating the operations of layout information correction processing according to the second embodiment of the invention.

FIG. 28 is a diagram illustrating a modified example of the software keyboard according to the second embodiment of the invention.

### DETAILED DESCRIPTION OF EMBODIMENTS

Descriptions are provided hereinbelow for embodiments based on the drawings. In the respective drawings referenced herein, the same constituents are designated by the same reference numerals and any duplicate explanation concerning the same constituents is omitted. All of the drawings are provided to illustrate the respective examples only.

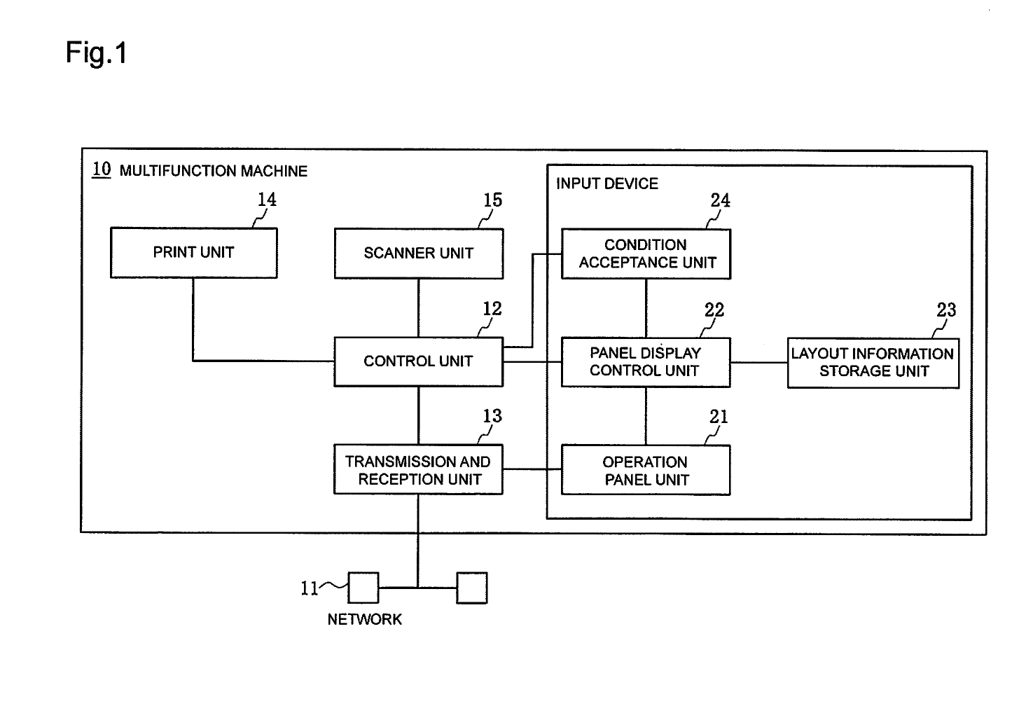

FIG. 1 is a block diagram illustrating a configuration of an image processing apparatus according to a first embodiment of the invention.

In FIG. 1, reference numeral 10 denotes a multifunction machine as the image processing apparatus according to this embodiment, having combined functions of a printer, a fax machine, a copying machine and a scanner. However, the image processing apparatus may be any kind of apparatus as long as the apparatus executes image processing such as read, print and transmission and reception of images. Therefore, the image processing apparatus may be a single-function machine such as a printer, a fax machine, a copying machine or a scanner.

Multifunction machine 10 is connected to network 11 to the outside and includes control unit 12, transmission and reception unit 13, print unit 14 as an image processing unit, scanner unit 15, operation panel unit 21 configured to display a software keyboard, panel display control unit 22 as a software keyboard display instruction unit, layout information storage unit 23, and condition acceptance unit 24. Note that operation panel unit 21, panel display control unit 22, layout information storage unit 23 and condition acceptance unit 24 function together as an input device.

Control unit 12 performs the overall control of the operations of multifunction machine 10.

Transmission and reception unit 13 is an interface between multifunction machine 10 and network 11, and allows multifunction machine 10 to perform communication through network 11. To be more specific, transmission and reception unit 13 receives print data from an unillustrated information processor connected to network 11, and transmits the print data to control unit 12. Moreover, transmission and reception unit 13 transmits image data to the information processor through network 11, the image data being created by control unit 12 controlling scanner unit 15. Transmission and reception unit 13 also transmits the image data to an unillustrated mail server connected to network 11.

Print unit 14 performs printing of the print data received from control unit 12. To be more specific, print unit 14 rasterizes the print data and performs printing, in the case of electrophotographic printing for example, by forming an electrostatic latent image on a photosensitive drum and then transferring a toner image onto recording paper, the toner image being obtained by developing the electrostatic latent image with a toner. Note that control unit 12 acquires the print data through transmission and reception unit 13 from the information processor connected to network 11.

Control unit 12 may start the printing by not immediately handing over the acquired print data to print unit 14 but handing over the print data to print unit 14 after authentication based on a password. To be more specific, upon reception of print data with password information, control unit 12 stores the print data. Then, control unit 12 receives a password entered by a user from panel display control unit 22. When the password coincides with a password of the stored print data, the control unit hands over the print data to print unit 14 to start printing.

Scanner unit 15 reads images from a document such as paper to create image data. The created image data is handed over from scanner unit 15 to control unit 12. Control unit 12 hands over the image data to print unit 14 for printing, and thus performs a copying thereof. Control unit 12 can also transmit the image data to the information processor connected to network 11 through transmission and reception unit 13. For example, control unit 12 may attach the image data as an attached file to an e-mail and transmit the e-mail to the mail server connected to network 11 through transmission and reception unit 13.

Operation panel unit 21 is a user interface of multifunction machine 10 and combines the functions of a display unit and an input unit.

Panel display control unit 22 performs display control of operation panel unit 21 according to instructions received from control unit 12. Also, panel display control unit 22 accepts an input to operation panel unit 21 by the user, and notifies control unit 12 of the input.

Layout information storage unit 23 stores layout information of members displayed on operation panel unit 21, i.e., information about the display modes. In this embodiment, layout information storage unit 23 stores information about layout modes and display modes of keys on a software keyboard, in particular, as software keyboard layout information.

Condition acceptance unit 24 accepts conditions for selecting the software keyboard layout information. Meanwhile, panel display control unit 22 determines the software keyboard layout information to be displayed on operation panel unit 21, based on the conditions accepted by condition acceptance unit 24.

Next, a configuration of operation panel unit 21 is described in detail.

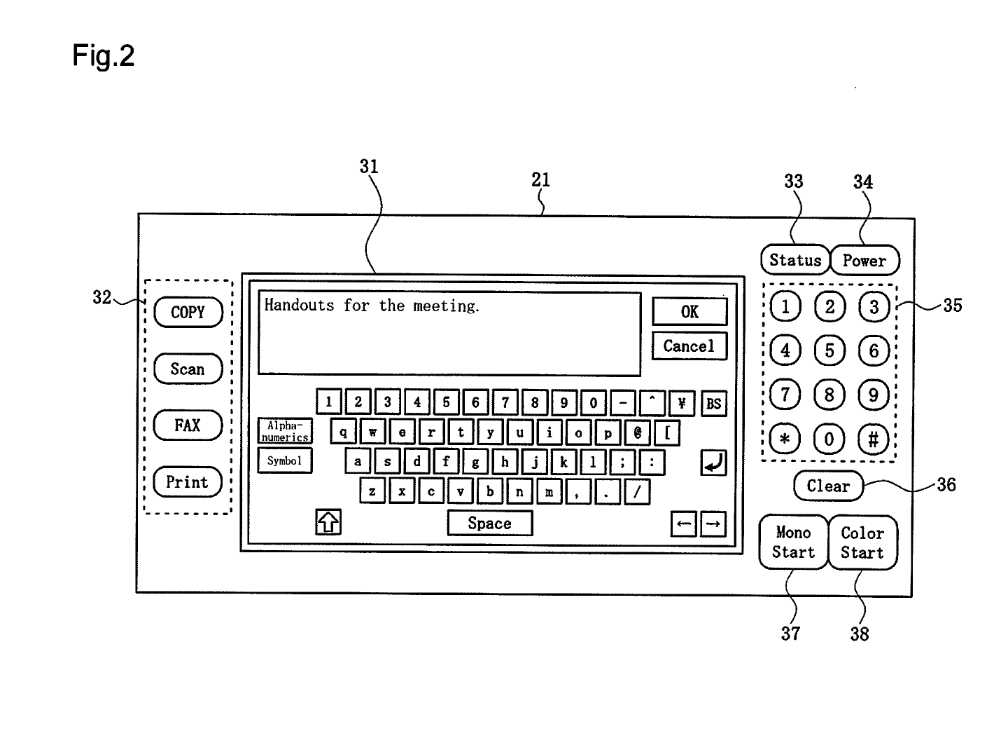

FIG. 2 is a diagram illustrating the configuration of the operation panel unit according to the first embodiment of the invention.

As illustrated in FIG. 2, operation panel unit 21 includes display section 31, function selection key section 32, status check key 33, power control key 34, numerical keypad section 35, clear key 36, monochrome start key 37 and color start key 38.

Display section 31 is a touch panel section including a so-called touch panel as an input member, and combines the functions of a display member and an input member. Meanwhile, function selection key section 32, status check key 33, power control key 34, numerical keypad section 35, clear key 36, monochrome start key 37 and color start key 38 are hardware keys and buttons to be pressed by the user. Note that the broken lines indicating function selection key section 32 and numerical keypad section 35 are drawn for convenience of explanation, and do not appear in an actual operation panel unit.

Function selection key section 32 includes buttons, i.e., hardware keys to select functions as a copying machine, a fax machine, a scanner and a printer. When the “COPY” key is pressed, for example, a COPY setting screen is displayed on display section 31.

Status check key 33 is a hardware key to check the status of multifunction machine 10. When status check key 33 is pressed, the status of multifunction machine 10 is displayed on display section 31.

Power control key 34 is a hardware key to control the power of multifunction machine 10. When power control key 34 is pressed, the power of multifunction machine 10 is switched on or off. Numerical keypad section 35 includes buttons, i.e., hardware keys to type numbers and symbols. Clear key 36 is a hardware key to delete strings of characters that are being typed in. Monochrome start key 37 is a hardware key to allow multifunction machine 10 to start operations such as copy, scan, fax transmission and reception, and print in black and white. Color start key 38 is a hardware key to allow multifunction machine 10 to start operations such as copy, scan, fax transmission and reception, and print in color.

Display section 31 displays a software keyboard that is a keyboard drawn by software. The software keyboard includes key layout modes different for every application program that is being run. However, the software keyboard displayed in this embodiment maintains the key layout mode while changing the display mode for some of the keys according to conditions, even when the application program is changed. Also, in this embodiment, a description is given of the case where the application program is a program for typing in general strings of characters such as sentences, e-mail addresses and authentication passwords.

Note that, although the description is given of the case where operation panel unit 21 is the combination of the touch panel and hardware keys, operation panel unit 21 may include only the touch panel.

Next, a detailed description is given of the software keyboard layout information corresponding to each application program. Note that the software keyboard layout information in this embodiment is described in XML (eXtensible Markup Language).

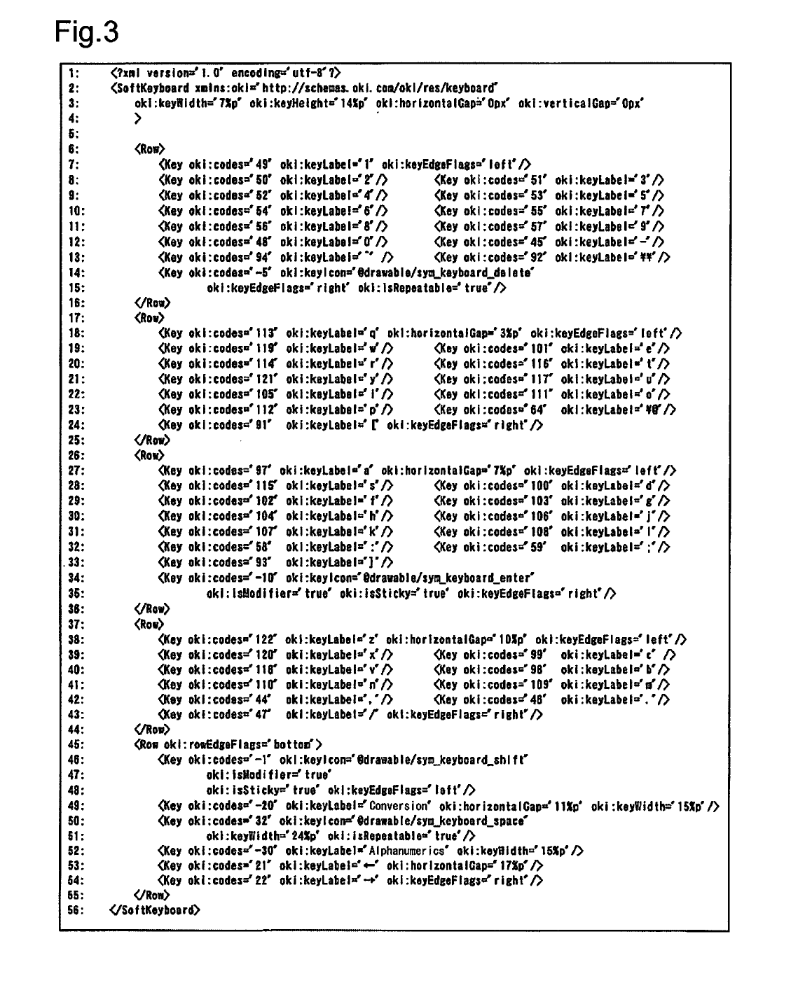

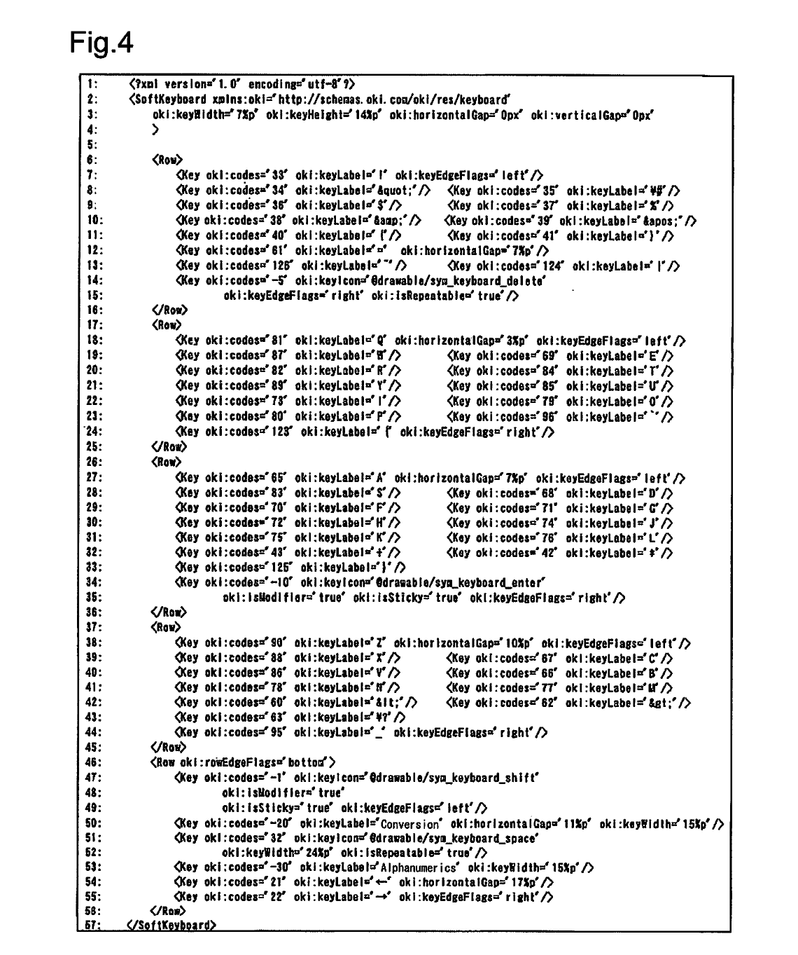

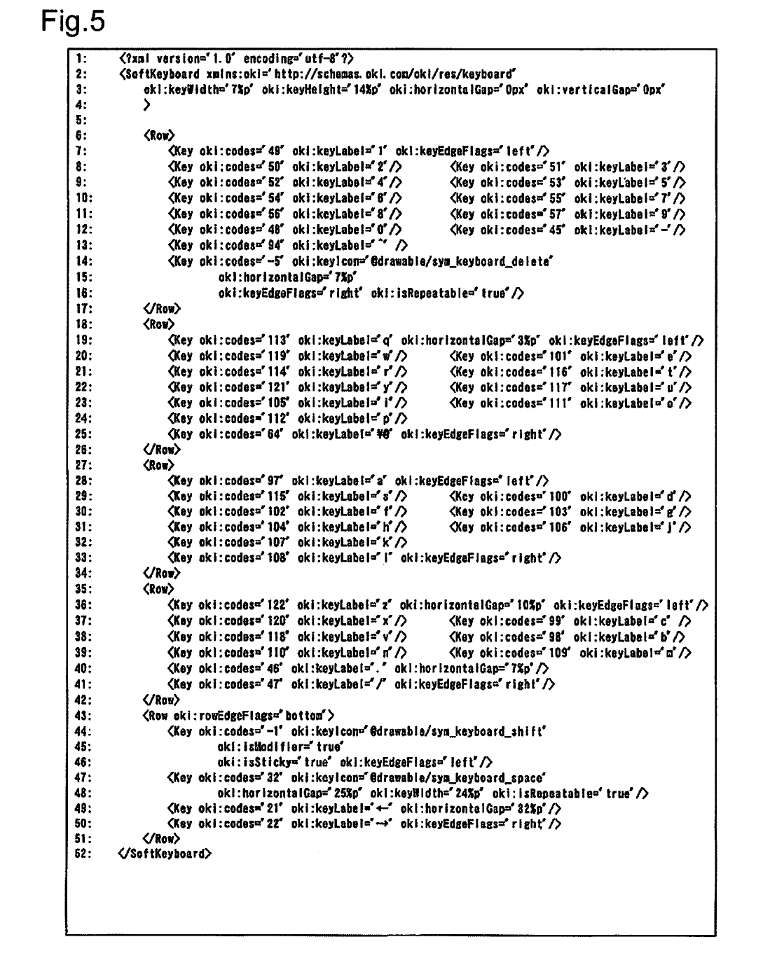

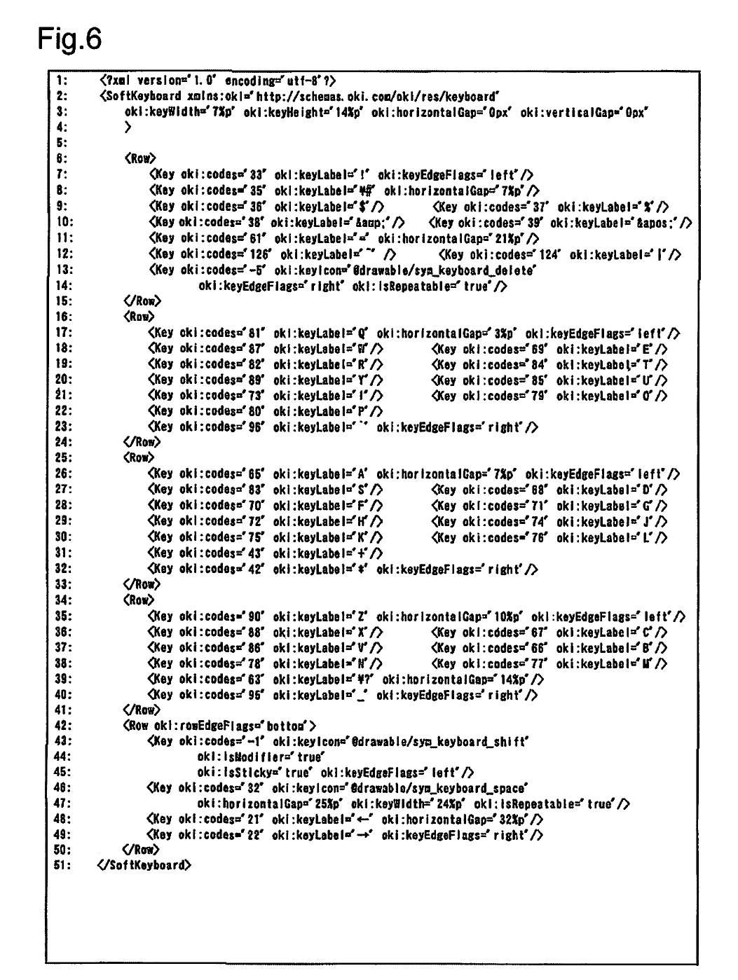

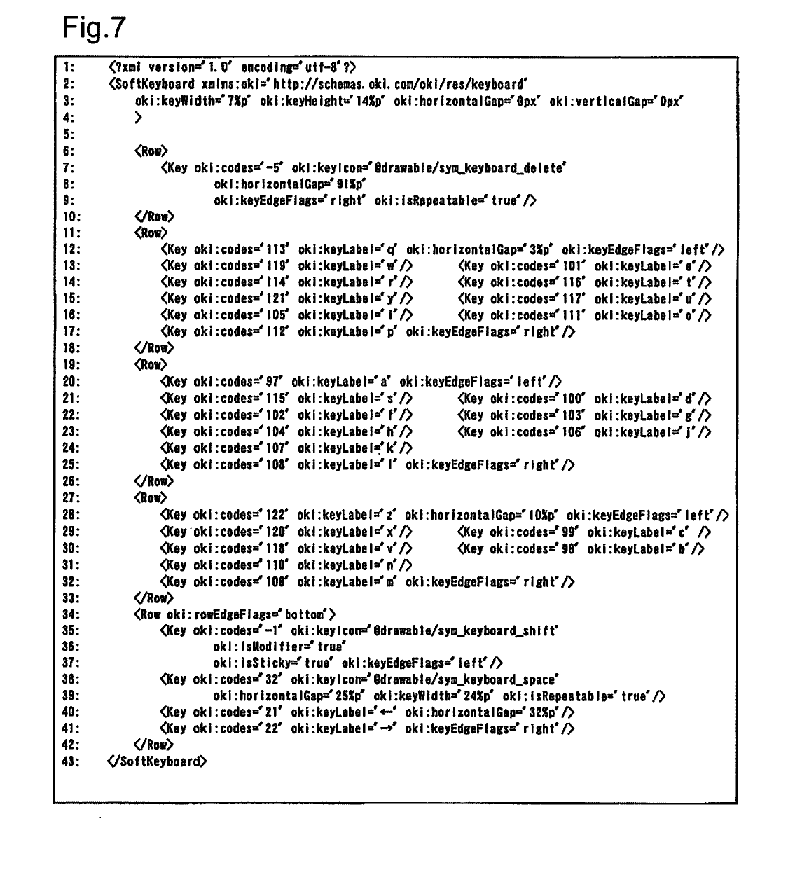

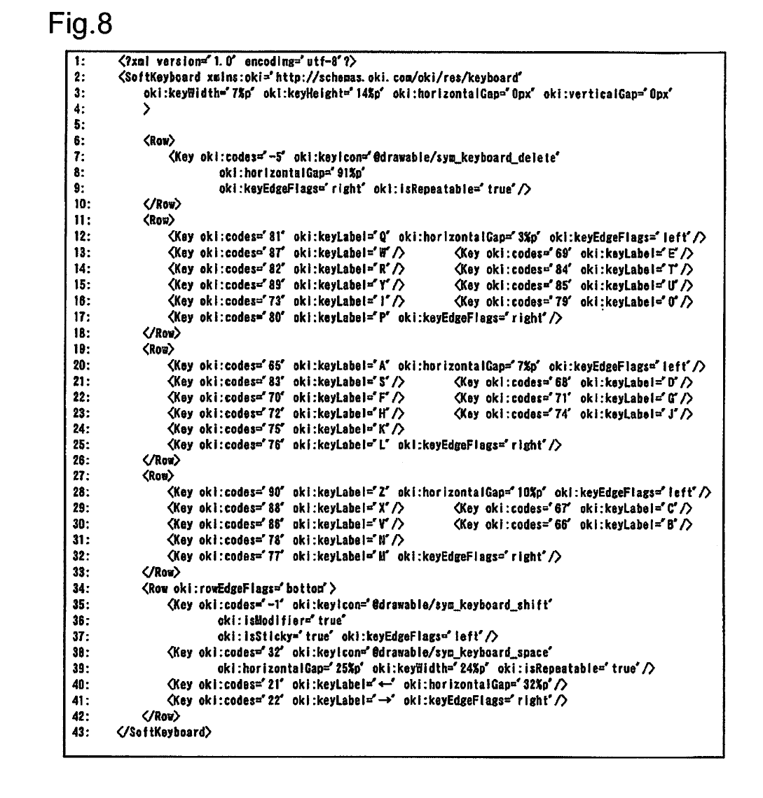

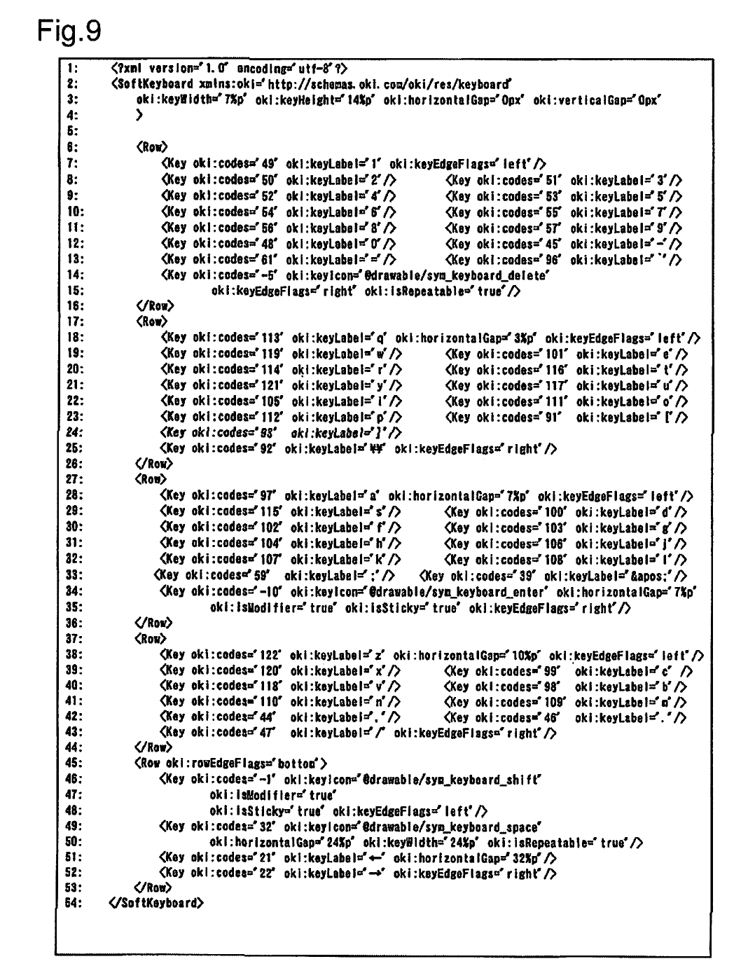

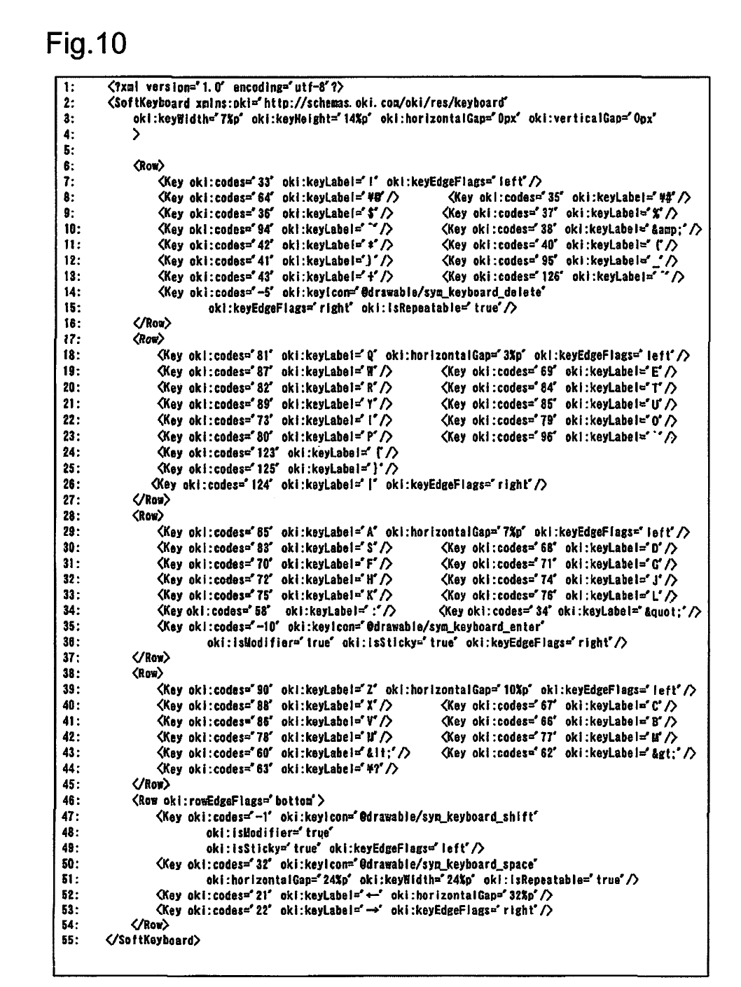

FIG. 3 is a diagram illustrating layout information of a general-purpose software keyboard to type sentences when the language information of the image processing apparatus is Japanese according to the first embodiment of the invention. FIG. 4 is a diagram illustrating layout information in a state where a shift key is pressed on the general-purpose software keyboard to type sentences when the language information of the image processing apparatus is Japanese according to the first embodiment of the invention. FIG. 5 is a diagram illustrating layout information of a dedicated software keyboard to type e-mail addresses when the language information of the image processing apparatus is Japanese according to the first embodiment of the invention. FIG. 6 is a diagram illustrating layout information in a state where a shift key is pressed on the dedicated software keyboard to type e-mail addresses when the language information of the image processing apparatus is Japanese according to the first embodiment of the invention. FIG. 7 is a diagram illustrating layout information of a dedicated software keyboard to type passwords when the language information of the image processing apparatus is Japanese according to the first embodiment of the invention. FIG. 8 is a diagram illustrating layout information in a state where a shift key is pressed on the dedicated software keyboard to type passwords when the language information of the image processing apparatus is Japanese according to the first embodiment of the invention. FIG. 9 is a diagram illustrating layout information of a general-purpose software keyboard to type sentences when the language information of the image processing apparatus is English according to the first embodiment of the invention. FIG. 10 is a diagram illustrating layout information in a state where a shift key is pressed on the general-purpose software keyboard to type sentences when the language information of the image processing apparatus is English according to the first embodiment of the invention.

FIG. 3 illustrates layout information of a general-purpose software keyboard to type sentences when the language information of multifunction machine 10 is Japanese. A file name is “ja_im1_main.xml”. FIG. 4 illustrates software keyboard layout information displayed when a shift key is pressed on the software keyboard displayed on display section 31 based on the layout information illustrated in FIG. 3. A file name is “ja_im1_main_shift.xml”.

FIG. 5 illustrates layout information of a dedicated software keyboard to type e-mail addresses when the language information of multifunction machine 10 is Japanese. A file name is “ja_im1_mail.xml”. FIG. 6 illustrates software keyboard layout information displayed when a shift key is pressed on the software keyboard displayed on display section 31 based on the layout information illustrated in FIG. 5. A file name is “ja_im1_mail_shift.xml”.

FIG. 7 illustrates layout information of a dedicated software keyboard to type passwords when the language information of multifunction machine 10 is Japanese. A file name is “ja_im1_password.xml”. FIG. 8 illustrates the software keyboard layout information displayed when a shift key is pressed on the software keyboard displayed on display section 31 based on the layout information illustrated in FIG. 7. A file name is “ja_im1_password_shift.xml”.

FIG. 9 illustrates layout information of a general-purpose software keyboard to type sentences when the language information of multifunction machine 10 is English. A file name is “en_im1_main.xml”. FIG. 10 illustrates the software keyboard layout information displayed when a shift key is pressed on the software keyboard displayed on display section 31 based on the layout information illustrated in FIG. 9. A file name is “en_im1_main_shift.xml”.

Note that the numbers at the line heads in FIGS. 3 to 10 are serial numbers for the purpose of illustration.

Here, the layout information illustrated in FIG. 3 is concretely described.

First, the first line is a typical XML declaration statement.

Then, the second to fourth lines define the size of, and interval between, the keys on the software keyboard.

Subsequently, the sixth to sixteenth lines define keys displayed in one row as a “Row” element. “Row” is sequentially displayed from the top of the screen of display section 31.

The seventh to fifteenth lines define the respective keys. The keys are displayed sequentially from the left within one row. The content defined by a “Key” element represents one key. The seventh line, for example, defines a key displayed as “Key”. In the “Key” element, the “oki:keyLabel” attribute represents a label of a button displayed as a key on the software keyboard, the “oki:codes” attribute represents a character code issued when the key is pressed, and the “oki:keyEdgeFlags” attribute represents horizontal layout information of the key. This means, in this example, the key is displayed at the far left.

The keys defined in the fourteenth and fifteenth lines are control keys. The control keys are distinguished from the other keys (keys to enter characters) by having negative codes.

The “oki:keyIcon” attribute represents a definition that an icon is used as a label of a button displayed as the key.

The “oki:isRepeatable” attribute represents whether or not to automatically make repetitive entries by holding down the key for a long time.

The “oki:horizontalGap” attribute in the eighteenth line sets a leftward space.

The “oki:isModifier” attribute in the forty-seventh line represents whether or not the key is a decorative key. If this attribute value is “true”, pressing the key means that the software keyboard layout displayed needs to be changed. When the software keyboard is displayed based on the layout information illustrated in FIG. 3 and the key is pressed, a software keyboard based on the layout information illustrated in FIG. 4 is displayed.

The “oki:isSticky” attribute in the forty-eighth line represents that the key is a toggle key (a key that is kept in a pressed state until the key is pressed again).

The “oki:keyWidth” attribute in the forty-ninth line represents a display width of the key.

Next, the software keyboard displayed on display section 31 is described in detail.

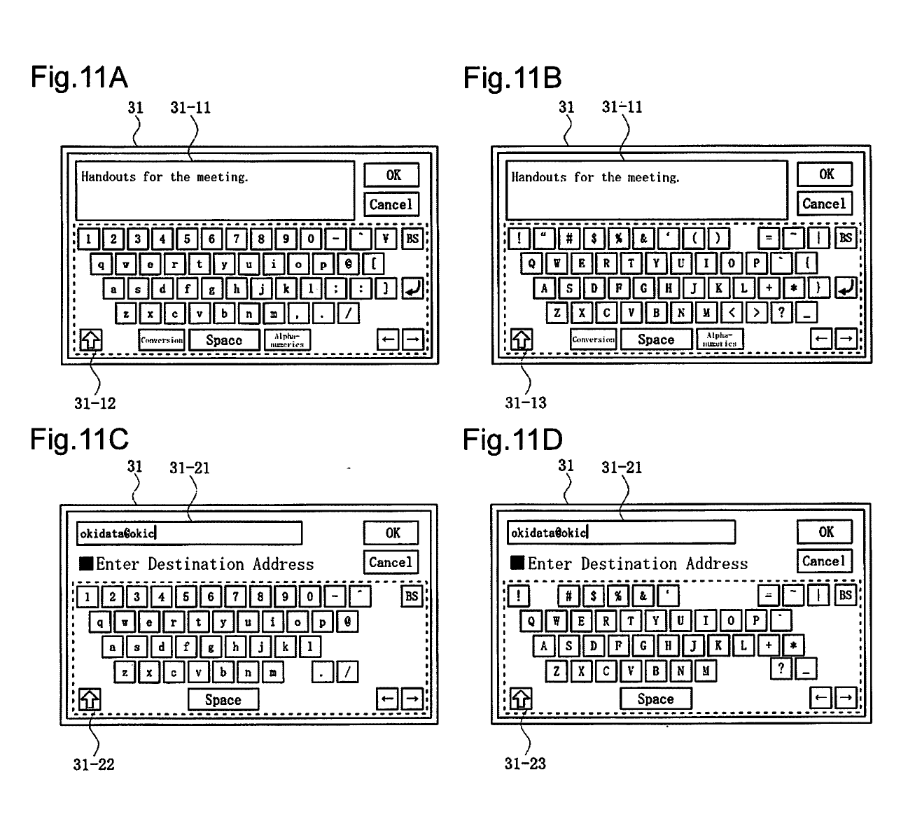

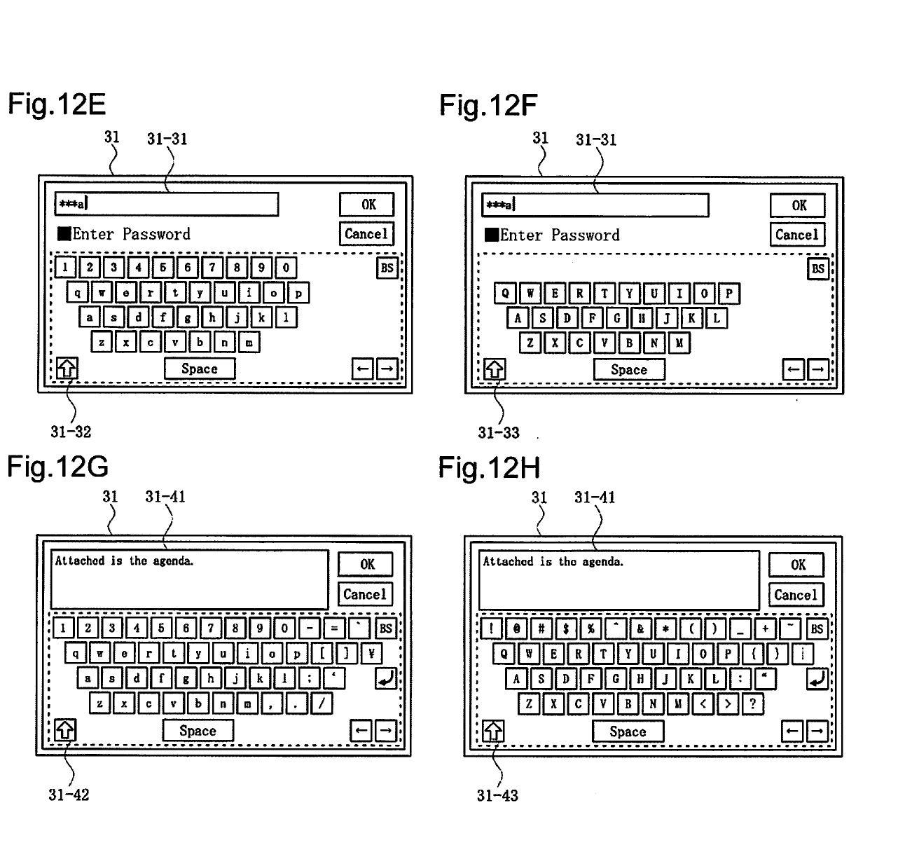

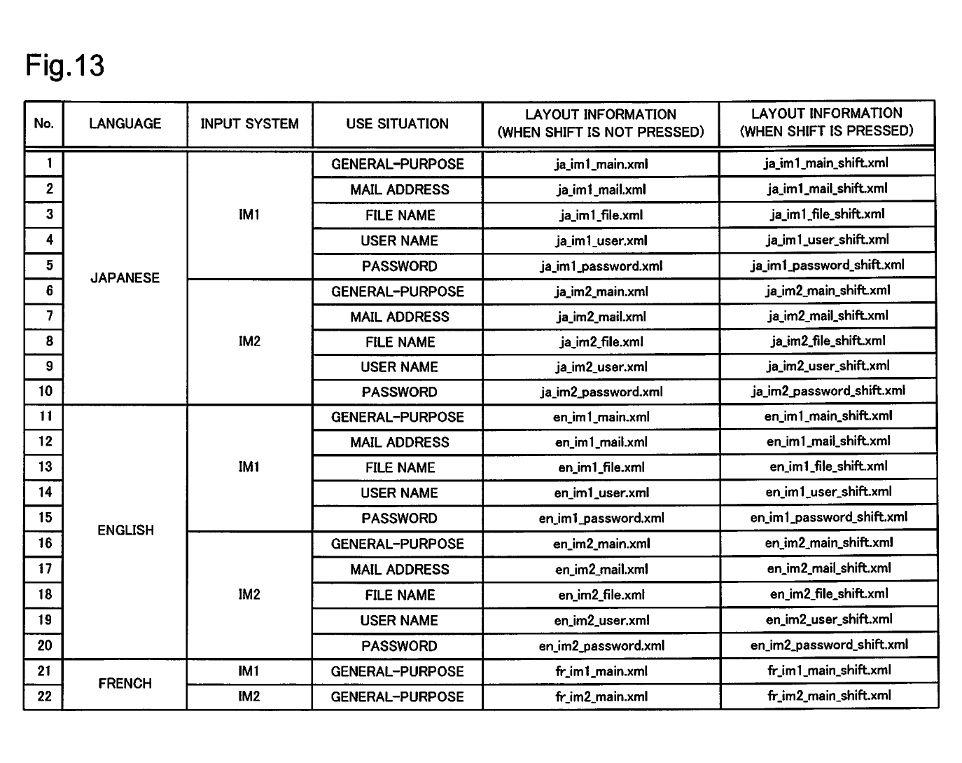

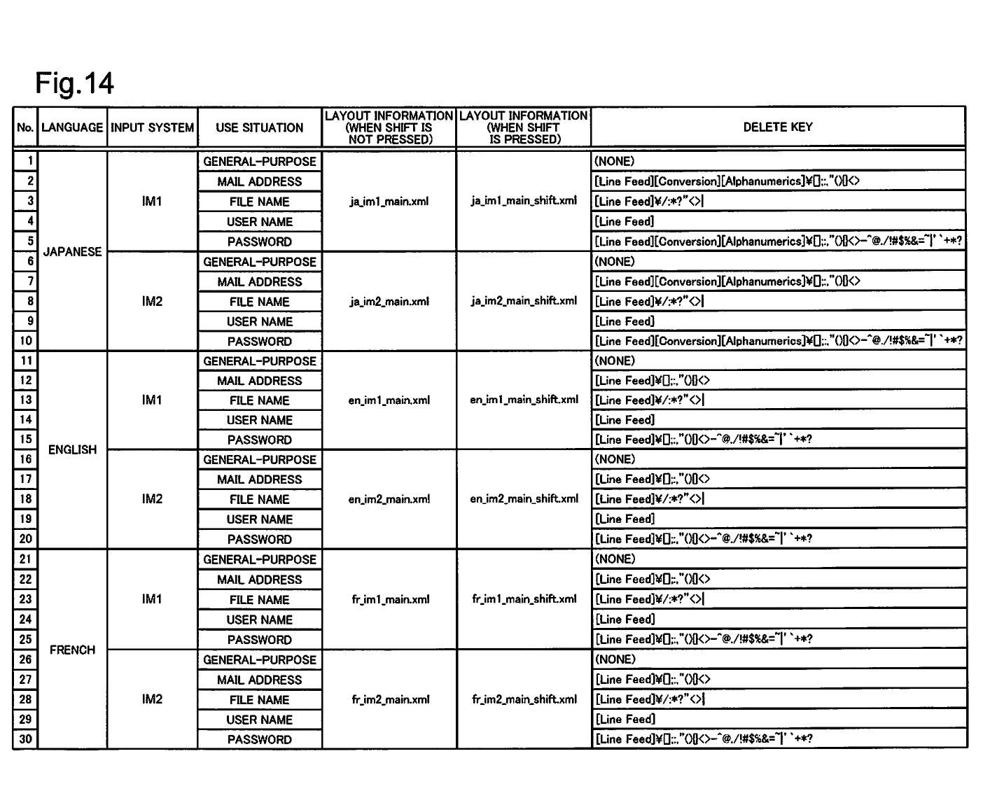

FIGS. 11A to 11D are first diagrams illustrating an example of a software keyboard according to the first embodiment of the invention. FIGS. 12E to 12H are second diagrams illustrating an example of the software keyboard according to the first embodiment of the invention. FIG. 13 is a table illustrating conditions of use of layout information of the software keyboard according to the first embodiment of the invention. FIG. 14 is a table illustrating a relation between a delete key and the conditions of use of the layout information of the software keyboard according to the first embodiment of the invention.

Note that, FIGS. 11A to 11D and FIGS. 12E to 12H illustrate examples of the software keyboard displayed based on the layout information illustrated in FIGS. 3 to 10. Also, the broken lines in FIGS. 11 and 12 are drawn for convenience of explanation, and do not appear on an actual software keyboard.

In FIGS. 11A to 11E and FIGS. 12E to 12H, 31-11, 31-21, 31-31 and 31-41 are text-entry fields where character strings are displayed, which are entered by the user pressing the keys on the software keyboard displayed on display section 31. Note that FIGS. 12E and 12F each illustrate a dedicated software keyboard to enter a password. Thus, as to a character string displayed in text-entry field 31-31, characters other than the last entered character are displayed as “*” and protected.

In this embodiment, an input system (Input Method: IM) that is software for entering characters into a computer detects a pressing of the keys on the software keyboard by the user and displays characters corresponding to the pressed keys in the text-entry fields. The input system is software to additionally display characters in the text-entry fields by using character codes corresponding to the pressed keys. Also, a conversion from Hiragana to Kanji is performed as necessary.

As illustrated in FIGS. 11 and 12, the software keyboards in this embodiment includes shift keys 31-12, 31-13, 31-22, 31-23, 31-32, 31-33, 31-42 and 31-43. The layout of the software keyboard is changed to corresponding layouts by the user pressing shift keys 31-12, 31-13, 31-22, 31-23, 31-32, 31-33, 31-42 and 31-43.

To be more specific, when the user presses shift keys 31-12, 31-22, 31-32 and 31-42 on the software keyboards illustrated in FIGS. 11A and 11C and FIGS. 12E and 12G, the layouts of the keyboards are switched to those illustrated in FIGS. 11B and 11D and FIGS. 12F and 12H, respectively. Likewise, when the user presses shift keys 31-13, 31-23, 31-33 and 31-43 on the software keyboards illustrated in FIGS. 11B and 11D and FIGS. 12F and 12H, the layouts of the keyboards are switched to those illustrated in FIGS. 11A and 11C and FIGS. 12E and 12G, respectively. Note that such a change in layout of the software keyboard is made by the input system.

As described above, condition acceptance unit 24 accepts conditions for selecting the software keyboard layout information. Meanwhile, panel display control unit 22 determines the software keyboard layout information to be displayed, based on the conditions accepted by condition acceptance unit 24.

FIG. 13 illustrates an example of correspondence between the conditions for selecting the software keyboard layout information and the layout information corresponding thereto. In this embodiment, the conditions for determining the layout information are “language”, “input system” and “use situation”. Here, “language” is language information set for multifunction machine 10, and “use situation” is a situation where the software keyboard is displayed. The information of “use situation” is given by an application program included in control unit 12 to display the software keyboard.

Note that, although the description is given of the case where panel display control unit 22 determines the software keyboard layout information to be displayed, based on the conditions accepted by condition acceptance unit 24, the invention is not limited thereto. For example, panel display control unit 22 may create layout information by deleting a key according to the conditions from the layout information defined in XML.

FIG. 14 illustrates an example of correspondence between the conditions for selecting the software keyboard layout information, the layout information corresponding thereto, and key deletion information. In this example, a “delete key” column is added to the example illustrated in FIG. 13. In the “delete key” column, character codes are defined.

Moreover, in the example illustrated in FIG. 14, for convenience of explanation, characters corresponding to the character codes are displayed. Note that characters enclosed in [ ] are control keys. A character code of “line feed” is −10, a character code of “conversion” is −20, and a character code of “alphanumerics” is −30.

When the conditions as illustrated in FIG. 14 are used, panel display control unit 22 deletes a key from the layout information, the key including, as an attribute value of “oki:codes”, a character code defined in the “delete key” column as unnecessary key information from the XML as the selected layout information.

Note that a comparison between the software keyboards illustrated in (A), (C), (E) and (G) of FIGS. 11 and 12 makes it possible to easily understand the fact that, even if the application program is changed and the conditions accepted by condition acceptance unit 24 are changed, the display mode of some of the keys is changed, i.e., some unnecessary keys are deleted and not displayed while maintaining the key layout mode. Likewise, a comparison between the software keyboards illustrated in FIGS. 11B and 11D and FIGS. 12F and 12H also makes it possible to easily understand the same. Note that some unnecessary keys can also be grayed out without being deleted so as not to be displayed.

Next, operations of multifunction machine 10 with the above configuration are described. First, an operation of displaying a software keyboard is described.

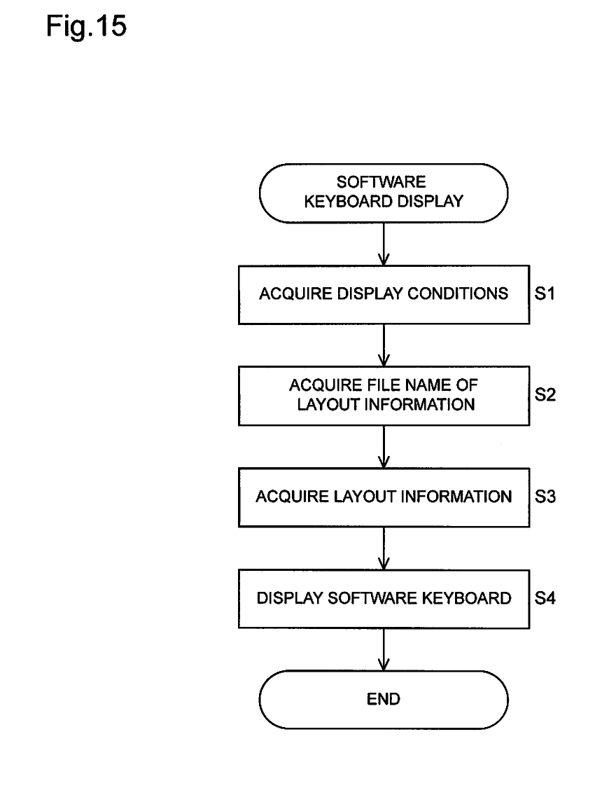

FIG. 15 is a flowchart illustrating the processing operations of displaying the software keyboard according to the first embodiment of the invention.

When panel display control unit 22 receives a software keyboard display instruction from control unit 12, the processing of displaying the software keyboard is started.

First, panel display control unit 22 allows condition acceptance unit 24 to execute the processing of acquiring conditions for displaying the software keyboard. Then, condition acceptance unit 24 acquires the conditions for displaying the software keyboard. The conditions are language information set for multifunction machine 10, the kind of the input system used by multifunction machine 10 and the use situation of the software keyboard, i.e., type information. The use situation is acquired from the application program included in control unit 12.

Thereafter, panel display control unit 22 acquires a file name of layout information as in the example illustrated in FIG. 13, based on the conditions for displaying the software keyboard, which are acquired by condition acceptance unit 24.

Here, to be more specific, the language information is “Japanese”, the input system is “IM1”, and the software keyboard use situation is a situation where the user is requested to enter his/her “password”. When the conditions as illustrated in FIG. 13 are used, for example, panel display control unit 22 acquires “ja_im1_password.xml” as in No. 5 in FIG. 13. Also, when the conditions as illustrated in FIG. 14 are used, for example, panel display control unit 22 acquires “ja_im1_main.xml”.

Subsequently, panel display control unit 22 acquires software keyboard layout information based on the acquired file name.

When the acquired file name is “ja_im1_password.xml”, for example, panel display control unit 22 acquires software keyboard layout information as illustrated in FIG. 7, which is described in XML. Meanwhile, when the acquired file name is “ja_im1_main.xml”, for example, panel display control unit 22 acquires software keyboard layout information as illustrated in FIG. 3, which is described in XML, and also deletes a key from the layout information, the key outputting a character code defined in the “delete key” column as illustrated in FIG. 14.

Thereafter, panel display control unit 22 displays the software keyboard on operation panel unit 21 based on the acquired software keyboard layout information, and then terminates the processing.

When the software keyboard layout information as illustrated in FIG. 7 is acquired, for example, and also when the software keyboard layout information as illustrated in FIG. 3 is acquired and a key that outputs a character code defined in the “delete key” column is deleted, for example, the software keyboard as illustrated in FIG. 12E is displayed on operation panel unit 21.

Next, a flowchart is described.

Step S1: Acquire conditions for displaying a software keyboard.

Step S2: Acquire a file name of software keyboard layout information.

Step S3: Acquire software keyboard layout information.

Step S4: Display the software keyboard and terminate the processing.

Next, a description is given of the operations when executing scan to Email processing. Here, scan to Email is the processing executed by an application program to attach image data read by scanner unit 15 as an attached file to an e-mail (Email) and then transmit the e-mail to the mail server connected to network 11.

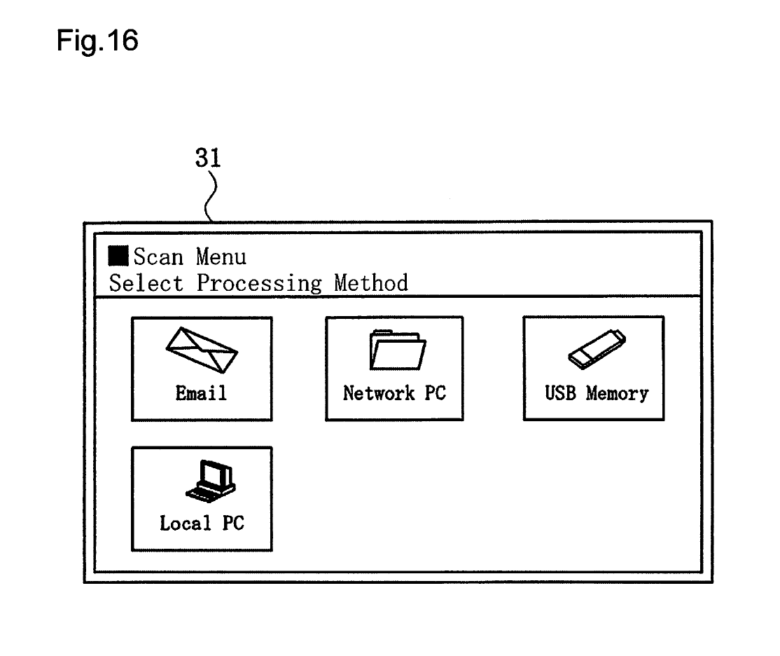

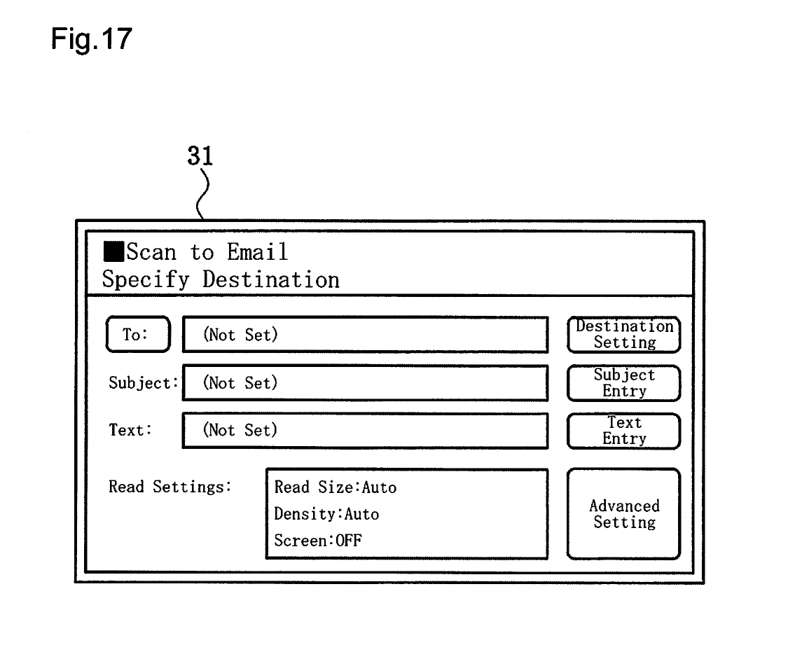

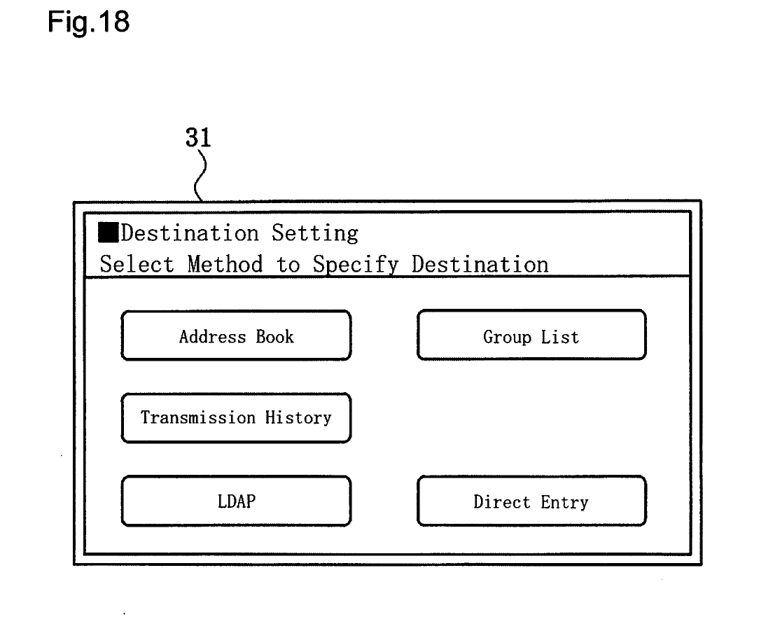

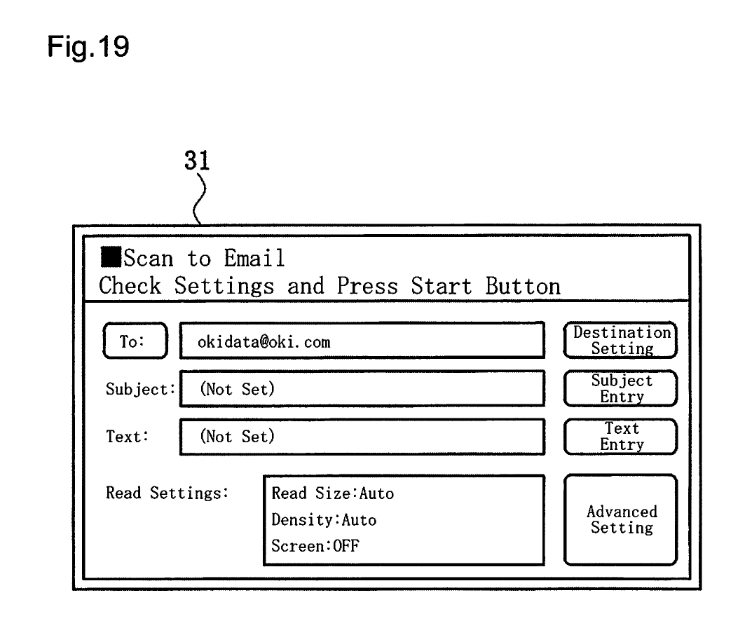

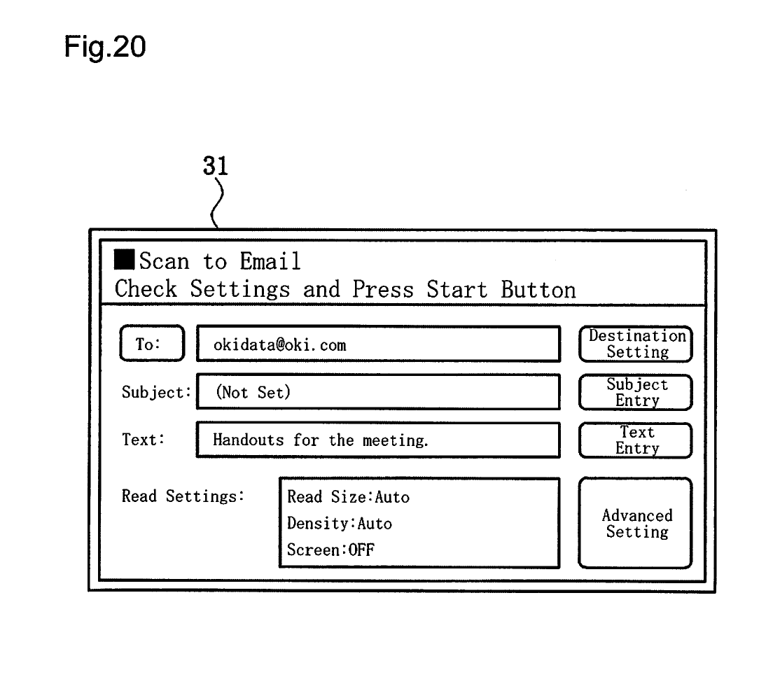

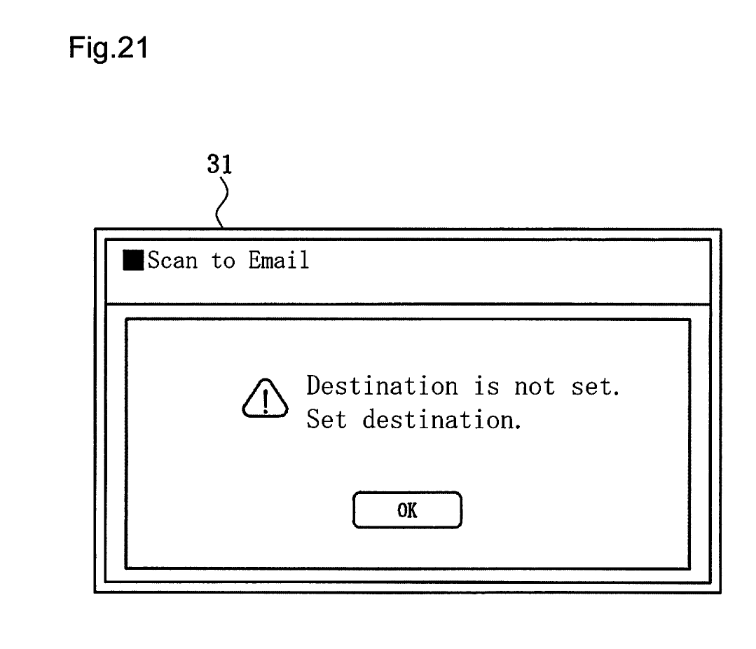

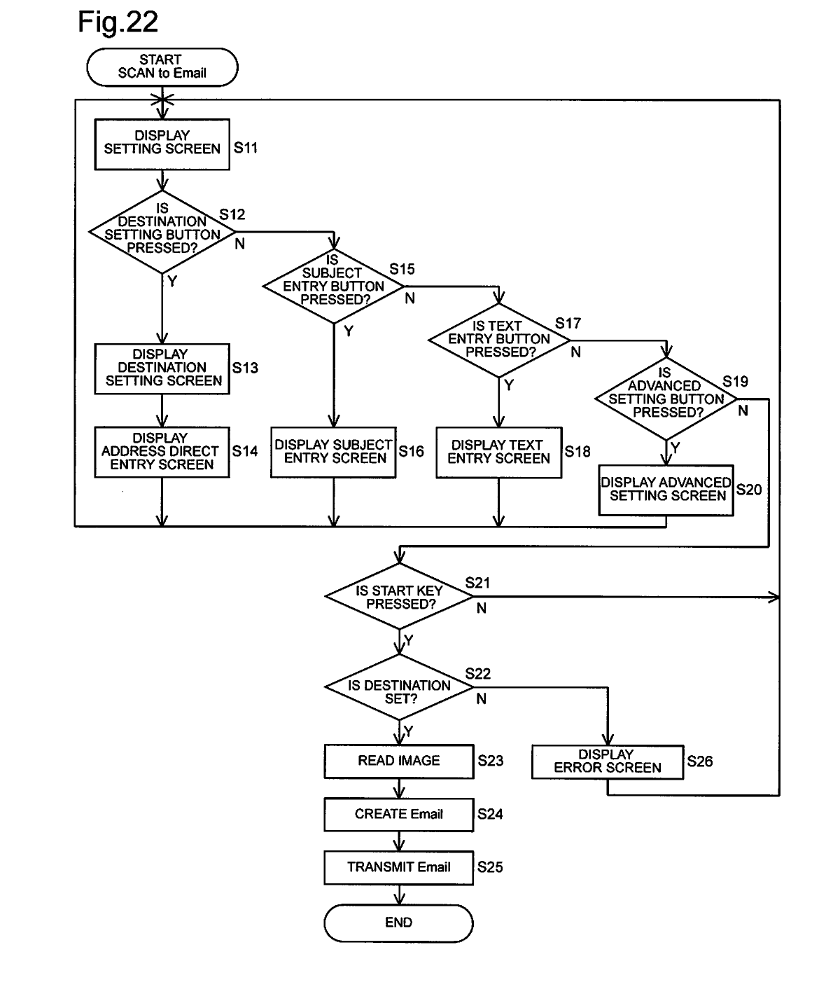

FIG. 16 is a diagram illustrating a scan menu displayed on a display unit according to the first embodiment of the invention. FIG. 17 is a first diagram illustrating a scan to Email setting screen displayed on the display unit according to the first embodiment of the invention. FIG. 18 is a diagram illustrating a destination setting screen displayed on the display unit according to the first embodiment of the invention. FIG. 19 is a second diagram illustrating the scan to Email setting screen displayed on the display unit according to the first embodiment of the invention. FIG. 20 is a third diagram illustrating the scan to Email setting screen displayed on the display unit according to the first embodiment of the invention. FIG. 21 is a diagram illustrating an error screen displayed on the display unit according to the first embodiment of the invention. FIG. 22 is a flowchart illustrating the operations of a scan to Email processing according to the first embodiment of the invention.

In this embodiment, the scan to Email processing is executed when the user of multifunction machine 10 presses the “Scan” key included in function selection key section 32 in operation panel unit 21, and also selects “Email” from a scan menu as illustrated in FIG. 16. These operations are executed by control unit 12 in multifunction machine 10. Note that the language information of multifunction machine 10 is “Japanese” and the input system is “IM1”.

First, panel display control unit 22 displays a scan to Email setting screen as illustrated in FIG. 17 on display section 31 in operation panel unit 21. Then, panel display control unit 22 waits until the user operates operation panel unit 21.

Then, when operation panel unit 21 is operated, panel display control unit 22 determines whether or not the “destination setting” button displayed on the setting screen as illustrated in FIG. 17 is pressed.

When the “destination setting” button is pressed, panel display control unit 22 displays a destination setting screen as illustrated in FIG. 18 on display section 31 in operation panel unit 21. In this embodiment, the user can select a method of setting a desired destination from among a selection from an address book, a selection from a group list (collection of addresses), a selection from an Email transmission history, acquisition from LDAP (Lightweight Directory Access Protocol) and direct entry. Here, a description is given of the case where “direct entry” is selected by the user.

Thereafter, panel display control unit 22 displays an address direct entry screen on display section 31 in operation panel unit 21. In this case, the use situation is “mail address” among the conditions for selecting the software keyboard layout information illustrated in FIG. 13. Thus, to be more specific, the software keyboard is displayed on display section 31 to enter an e-mail address as illustrated in FIG. 11C.

When the user operates the displayed software keyboard to enter an e-mail address, i.e., an e-mail address input from the user is received, panel display control unit 22 displays the scan to Email setting screen again on display section 31 in operation panel unit 21, and repeats the subsequent operations. In this case, a destination is set as illustrated in FIG. 19 on the scan to Email setting screen.

Then, when the “destination setting” button is not pressed as a result of the determination of whether or not “destination setting” button is pressed, panel display control unit 22 determines whether or not the “subject entry” button displayed on the scan to Email setting screen is pressed.

When the “subject entry” button is pressed, panel display control unit 22 displays a subject entry screen for entering a subject of an e-mail on display section 31 in operation panel unit 21. In this case, the use situation is “general-purpose” among the conditions for selecting the software keyboard layout information illustrated in FIG. 13. Thus, to be more specific, the software keyboard to enter Japanese sentences as illustrated in FIG. 11A is displayed on display section 31. When the user operates the displayed software keyboard to enter a subject of an e-mail, i.e., an e-mail subject input from the user is received, panel display control unit 22 displays the scan to Email setting screen again on display section 31 in operation panel unit 21, and repeats the subsequent operations.

When the “subject entry” button is not pressed as a result of the determination of whether or not the “subject entry” button is pressed, panel display control unit 22 determines whether or not the “text entry” button displayed on the scan to Email setting screen is pressed.

When the “text entry” button is pressed, panel display control unit 22 displays a text entry screen for entering a text of an e-mail on display section 31 in operation panel unit 21. In this case, the use situation is “general-purpose” among the conditions for selecting the software keyboard layout information illustrated in FIG. 13. Thus, to be more specific, the software keyboard to enter Japanese sentences as illustrated in FIG. 11A is displayed on display section 31. Note that, when the language information of multifunction machine 10 is “English”, the software keyboard to enter English sentences as illustrated in FIG. 12G is displayed on display section 31.

When the user operates the displayed software keyboard to enter the text of the e-mail, i.e., an e-mail text input from the user is received, panel display control unit 22 displays the scan to Email setting screen again on display section 31 in operation panel unit 21, and repeats the subsequent operations. In this case, a text is entered as illustrated in FIG. 20 on the scan to Email setting screen.

When the “text entry” button is not pressed as a result of the determination of whether or not “text entry” button is pressed, panel display control unit 22 determines whether or not the “advanced setting” button displayed on the scan to Email setting screen is pressed.

When the “advanced setting” button is pressed, panel display control unit 22 displays an advanced setting screen for entering advanced settings for scanner unit 15 to execute the reading of images on display section 31 in operation panel unit 21. Then, when the user operates the advanced setting screen to enter the advanced settings for scanner unit 15 to execute the reading of images, i.e., an advanced setting input from the user is received, panel display control unit 22 displays the scan to Email setting screen again on display section 31 in operation panel unit 21, and repeats the subsequent operations.

When the “advanced setting” button is not pressed as a result of the determination of whether or not the “advanced setting” button is pressed, panel display control unit 22 determines whether or not monochrome start key 37 or color start key 38 in operation panel unit 21 is pressed, i.e., a start key is pressed.

When the start key is not pressed, panel display control unit 22 displays the scan to Email setting screen again on display section 31 in operation panel unit 21, and repeats the subsequent operations.

On the other hand, when the start key is pressed as a result of the determination of whether or not the start key is pressed, panel display control unit 22 determines whether or not the e-mail address setting is completed, i.e., a destination is set. Since an e-mail cannot be transmitted if no destination is set, confirmation that the destination is set is required.

When the destination is set, control unit 12 allows scanner unit 15 to read images. Then, scanner unit 15 reads images from a document, such as paper, to create image data. The image data may be image data of a compression format such as JPEG (Joint Photographic Experts Group), for example.

Subsequently, control unit 12 creates an Email. To be more specific, control unit 12 attaches the image data created by scanner unit 15 to an e-mail as an attached file and sets the e-mail address, subject and text entered by the user operating operation panel unit 21, thus creating the e-mail.

Thereafter, control unit 12 transmits the Email and then terminates the processing. To be more specific, control unit 12 transmits the created e-mail to the mail server connected to network 11 through transmission and reception unit 13.

Meanwhile, when no destination is set after the determination of whether or not a destination is set, panel display control unit 22 displays an error screen for notifying the user of error contents on display section 31 in operation panel unit 21. To be more specific, an error screen as illustrated in FIG. 21 is displayed on display section 31. Then, when the user presses the “OK” button included in the error screen, panel display control unit 22 displays the scan to Email setting screen again on display section 31 in operation panel unit 21, and repeats the subsequent operations.

Note that the processing is suspended when any of the keys in function selection key section 32 in operation panel unit 21, i.e., status check key 33 or power control key 34, is pressed between the start and end of the processing.

Next, a flowchart is described.

Step S11: Display scan to Email setting screen.

Step S12: Determine whether or not the “destination setting” button is pressed. Proceed to Step S13 if “destination setting” button is pressed and proceed to Step S15 if the “destination setting” button is not pressed.

Step S13: Display a destination setting screen. The user selects from among a selection from an address book, a selection from a group list, a selection from an Email transmission history, an acquisition from LDAP and a direct entry.

Step S14: When the user selects direct entry, an address direct entry screen is displayed and the process returns to Step S11. Note that when a selection from the address book, a selection from the group list, a selection from the Email transmission history or an acquisition from LDAP is selected, an address book screen, a group list screen, an Email transmission history screen or an LDAP screen is displayed and the process returns to Step S11.

Step S15: Determine whether or not the “subject entry” button is pressed. Proceed to Step S16 if the “subject entry” button is pressed, and proceed to Step S17 if the “subject entry” button is not pressed.

Step S16: Display a subject entry screen for entering a subject of the e-mail, and then return to Step S11.

Step S17: Determine whether or not the “text entry” button is pressed. Proceed to Step S18 if the “text entry” button is pressed, and proceed to Step S19 if the “text entry” button is not pressed.

Step S18: Display a text entry screen for entering a text of the e-mail, and then return to Step S11.

Step S19: Determine whether or not the “advanced setting” button is pressed. Proceed to Step S20 if the “advanced setting” button is pressed, and proceed to Step S21 if the “advanced setting” button is not pressed.

Step S20: Display an advanced setting screen for entering advanced settings for scanner unit 15 to execute in the reading of images, and then return to Step S11.

Step S21: Determine whether or not the start key is pressed. Proceed to Step S22 if the start key is pressed, and return to Step S11 if the start key is not pressed.

Step S22: Determine whether or not a destination is set. Proceed to Step S23 if the destination is set, and proceed to Step S26 if no destination is set.

Step S23: Read images by scanner unit 15.

Step S24: Create Email.

Step S25: Transmit Email and terminate the processing.

Step S26: Display error screen and then return to Step S11.

As described above, in this embodiment, the software keyboard is displayed on display section 31 in operation panel unit 21 by acquiring software keyboard layout information (the keys to be displayed differ in type even though the key layout mode is not changed) corresponding to the conditions such as the language information, the kind of the input system and the use situation. Therefore, since a software keyboard corresponding to an item to be entered is displayed on display section 31, the user does not operate keys that cannot be used for entry. Thus, for the convenience for the user is improved. Moreover, since the layout of the software keyboard displayed on display section 31 is not changed in any situation, the user does not get confused.

Note that in the case of printing print data with password information stored in control unit 12, the user needs to enter his/her password. In this case, the use situation is “password” among the conditions for selecting the software keyboard layout information illustrated in FIG. 13. To be more specific, the software keyboard to enter a password as illustrated in FIG. 12E is displayed on display section 31. As described above, in this embodiment, the software keyboard includes different layouts based on the layout of the general-purpose software keyboard. Thus, the software keyboard that maintains the key layout mode can be displayed while changing the display mode for some of the keys according to the conditions, even when the application program is changed. In other words, the software keyboard can be switched without changing the basic key layout mode. Thus, the convenience for the user can be improved.

Next, a second embodiment of the invention is described. Note that the components having the same structures as those of the first embodiment are denoted by the same reference numerals, and descriptions thereof are omitted. Also, as to the same operations and effects as those of the first embodiment, such descriptions thereof are also omitted.

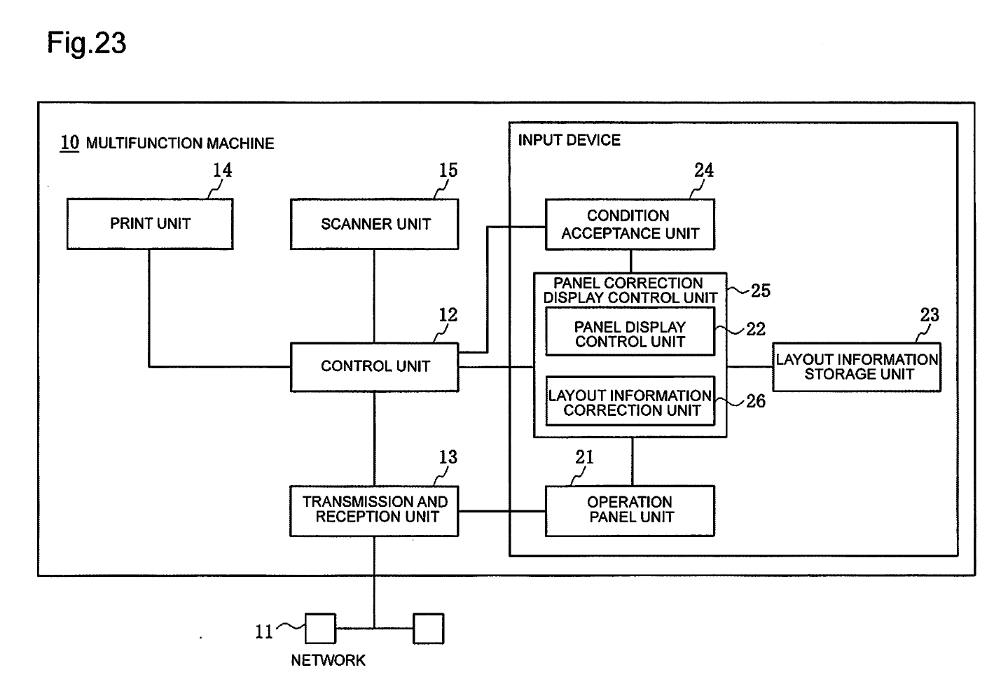

FIG. 23 is a block diagram illustrating a configuration of an image processing apparatus according to the second embodiment of the invention.

In this embodiment, multifunction machine 10 includes panel correction display control unit 25 as a software keyboard display instruction unit instead of panel display control unit 22 described in the first embodiment, and also includes a newly added layout information correction unit 26, as illustrated in FIG. 23.

Layout information correction unit 26 includes a function to correct the display of keys on a software keyboard displayed on operation panel unit 21. Layout information correction unit 26 also functions as a part of an input device. Meanwhile, panel correction display control unit 25 includes a function to display software keyboard layout information displayed on operation panel unit 21 after correcting the layout information by layout information correction unit 26, in addition to the function of panel display control unit 22 described in the first embodiment.

Note that, since the other configurations are the same as those in the first embodiment, descriptions thereof are omitted.

Next, the software keyboard layout information in this embodiment is described in detail.

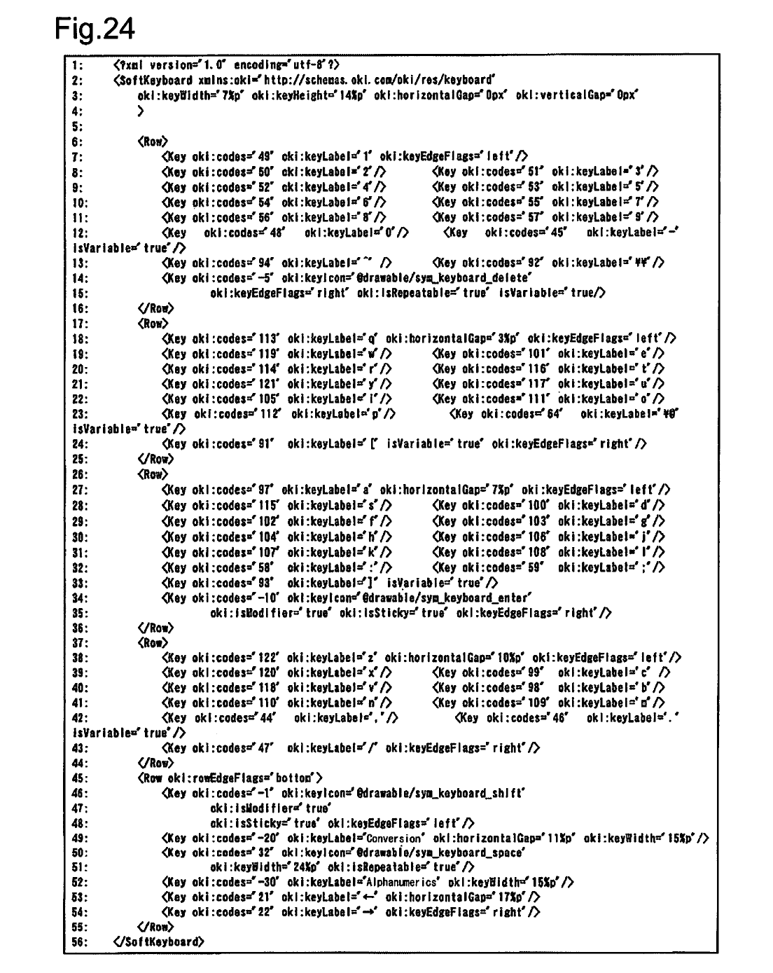

FIG. 24 is a diagram illustrating the layout information of a general-purpose software keyboard to type sentences when the language information of the image processing apparatus is Japanese according to the second embodiment of the invention.

The layout information illustrated in FIG. 24 is layout information of a general-purpose software keyboard to type sentences when the language information of multifunction machine 10 in this embodiment is Japanese. A file name is “ja_im1_main.xml”.

The layout information illustrated in FIG. 24 is different from that illustrated in FIG. 3 described in the first embodiment in that “isVariable” attributes are defined in elements of the twelfth, fifteenth, twenty-third, thirty-third and forty-second lines. The “isVariable” attributes are flag information that allows an enlarged display of the keys by using a gap generated in a layout of a software keyboard to be displayed by deletion of keys to be disposed in the corresponding lines by panel correction display control unit 25. Layout information correction unit 26 corrects the key layout by using the “isVariable” attributes.

Note that, since the other points about the software keyboard layout information are the same as those in the first embodiment, descriptions thereof are omitted.

Next, operations of multifunction machine 10 according to this embodiment are described. First, an operation of displaying a software keyboard is described.

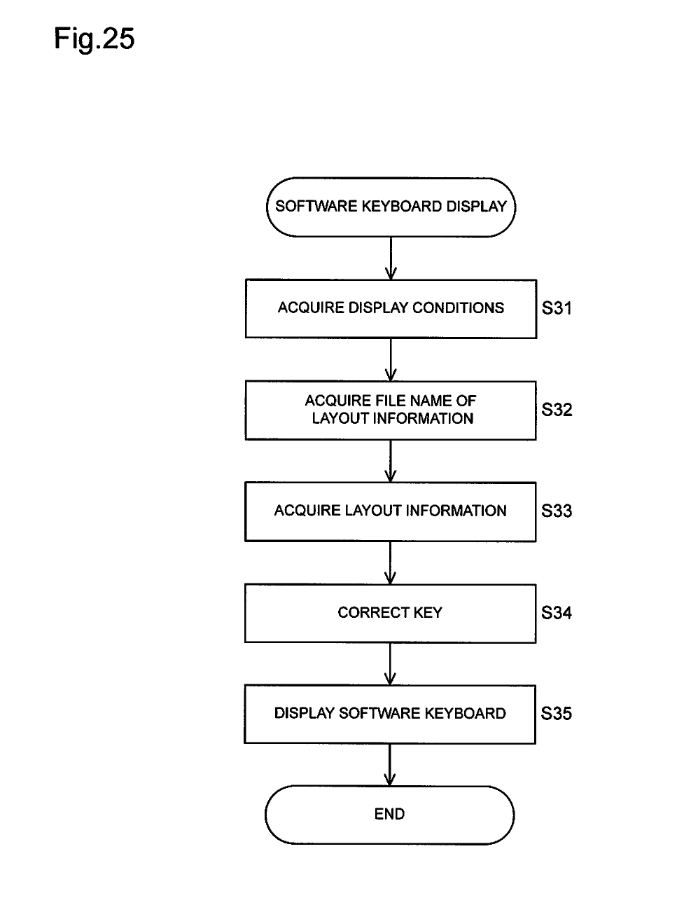

FIG. 25 is a flowchart illustrating the processing operations of displaying the software keyboard according to the second embodiment of the invention.

When panel correction display control unit 25 receives a software keyboard display instruction from control unit 12, the processing of displaying the software keyboard is started.

Note that operations up to the acquisition of software keyboard layout information after the start of the processing, i.e., the operations of Steps S31 to S33 in the flowchart, are the same as those of Steps S1 to S3 in the flowchart of the first embodiment, and thus descriptions thereof are omitted.

After the acquisition of the software keyboard layout information, panel correction display control unit 25 performs a key correction. To be more specific, panel correction display control unit 25 hands over the acquired software keyboard layout information to layout information correction unit 26 to instruct on the correction of the layout information.

Note that a subsequent operation, i.e., an operation of Step S35 in the flowchart, is the same as that of Step S4 in the flowchart of the first embodiment, and thus a description thereof is omitted.

Next, the flowchart is described.

Step S31: Acquire conditions for displaying a software keyboard.

Step S32: Acquire a file name of the software keyboard layout information.

Step S33: Acquire the software keyboard layout information.

Step S34: Correct keys.

Step S35: Display the software keyboard and terminate the processing.

Next, operations of layout information correction unit 26 are described. To be more specific, a description is given of the process of correcting the software keyboard layout information, i.e., operations when executing the layout information correction processing.

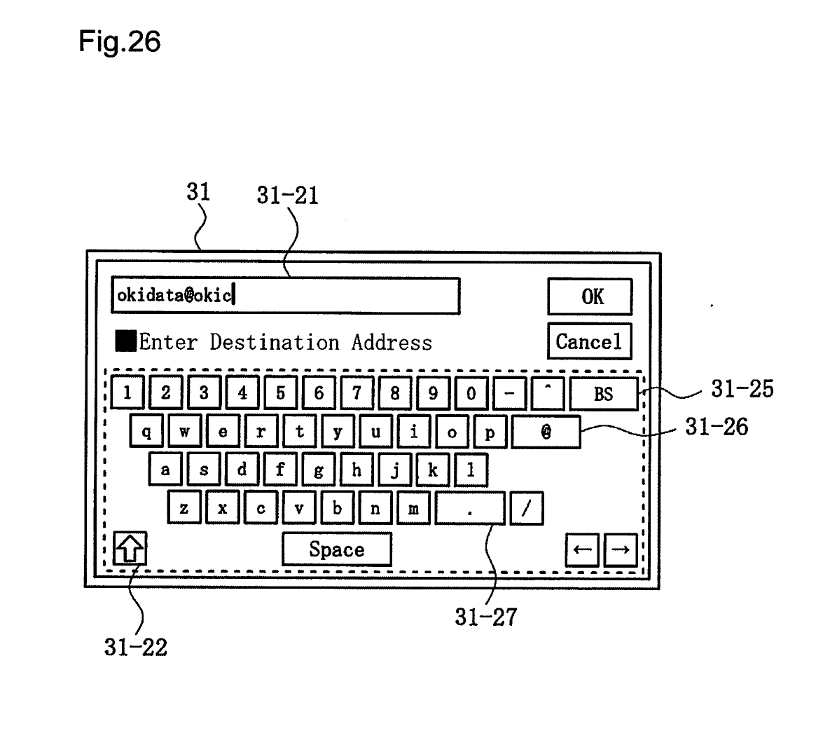

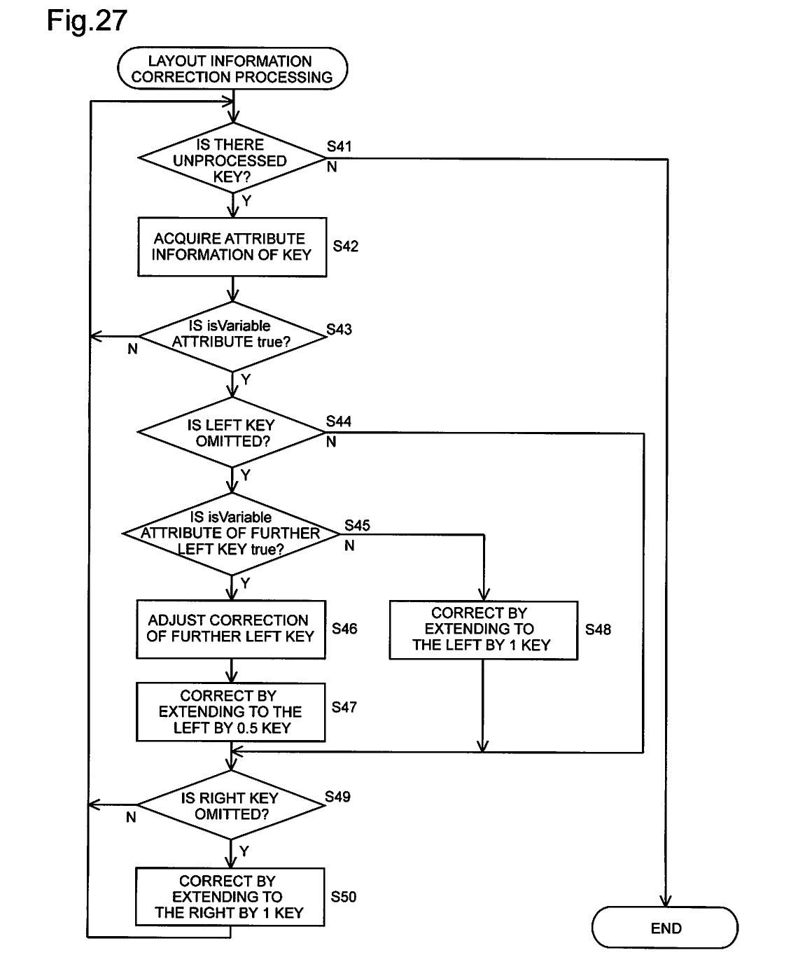

FIG. 26 is a diagram illustrating an example of the software keyboard according to the second embodiment of the invention. FIG. 27 is a flowchart illustrating the operations of the layout information correction processing according to the second embodiment of the invention.

Upon receipt of the software keyboard layout information and layout information correction instruction from panel correction display control unit 25, layout information correction unit 26 starts the layout information correction processing. Note that, in this embodiment, layout information correction unit 26 executes correction processing sequentially from the top of the layout information as illustrated in FIG. 24. More specifically, the correction processing is executed from left to right for the top row among the key rows on the software keyboard, as illustrated in FIG. 26. Then, the correction processing is executed from left to right for the second top row.

First, layout information correction unit 26 determines whether or not there is an unprocessed key. To be more specific, layout information correction unit 26 determines whether or not there is a key for which the correction processing is not completed among the keys defined in the software keyboard layout information. Then, if there is no key for which the processing is not completed, i.e., there is no unprocessed key, layout information correction unit 26 terminates the processing.

On the other hand, if there is a key for which the processing is not yet completed, i.e., an unprocessed key, layout information correction unit 26 acquires attribute information of the unprocessed key, i.e., the key still to be processed.

Thereafter, layout information correction unit 26 determines whether or not “isVariable” attribute is “true”. To be more specific, layout information correction unit 26 determines whether or not “isVariable” attribute is included in the acquired key attribute information and the value thereof is “true”. Then, if the “isVariable” attribute is not “true”, layout information correction unit 26 determines again whether or not there is an unprocessed key, and then repeats the subsequent operations.

On the other hand, if the “isVariable” attribute is “true”, then layout information correction unit 26 determines whether or not the left key is omitted, i.e., whether or not a key to the left of the key to be processed is omitted.

Then, if the left key is omitted, layout information correction unit 26 determines whether or not the “isVariable” attribute of a further left key is “true”. To be more specific, layout information correction unit 26 determines whether or not there is another key to the left of the omitted left key, and whether the “isVariable” attribute that is attribute information of the key is “true”, i.e., the key is corrected.

Here, if the “isVariable” attribute of the further left key is “true”, layout information correction unit 26 adjusts the correction of the further left key. To be more specific, if there is another key to the left of the omitted left key and that key is corrected, layout information correction unit 26 corrects a display region of the key to the right so as to extend the display region by 0.5 key, i.e., by half the width of one key.

Thereafter, layout information correction unit 26 corrects the display region to the left by extending the display region by 0.5 key. To be more specific, layout information correction unit 26 corrects the display region of the key to be processed to the left so as to extend the display region by 0.5 key, i.e., by half the width of one key. Accordingly, the keys positioned on both sides of the omitted key can be extended up to the middle of the omitted key, respectively.

Subsequently, layout information correction unit 26 determines whether or not a right key is omitted, i.e., whether or not a key to the right of the key to be processed is omitted. Then, if the right key is not omitted, layout information correction unit 26 determines again whether or not there is an unprocessed key, and then repeats the subsequent operations.

On the other hand, if the right key is omitted, layout information correction unit 26 corrects the display region by extending the display region to the right by one key. To be more specific, layout information correction unit 26 corrects the display region of the key to be processed so as to extend the display region to the right by one key, i.e., by the width of one key. Then, layout information correction unit 26 determines again whether or not there is an unprocessed key, and then repeats the subsequent operations.

Note that, if the “isVariable” attribute of the further left key is not “true” after the determination of whether or not the “isVariable” attribute thereof is “true”, i.e., if the key to the left of the omitted left key is not corrected, layout information correction unit 26 corrects the display region thereof by extending the display region to the left by one key. To be more specific, layout information correction unit 26 corrects the display region of the key to be processed so as to extend the display region to the left by one key, i.e., by the width of one key. Thereafter, layout information correction unit 26 determines whether or not the right key is omitted.

If the left key is not omitted after the determination of whether or not the left key is omitted, layout information correction unit 26 immediately determines whether or not the right key is omitted.

As described above, layout information correction unit 26 performs the correction such that the keys on both sides of the omitted key are displayed as being extended into the region of the omitted key. Thus, specific keys are enlarged. Note that, when a key is extended and displayed, the key may be extended so as to fill the region of the omitted key (a gap between the left and right keys) while fixing the central coordinate of the key. Moreover, the correction may be performed such that, in case of an erroneous touch by the user, keys representing usable characters are enlarged and displayed rather than extending and displaying the keys on both sides of the omitted key.

FIG. 26 illustrates an example of the software keyboard displayed on display section 31 in operation panel unit 21 after the layout information correction. In this example, the layouts of keys 31-25, 31-26 and 31-27 are corrected and laterally extended and displayed.

Next, the flowchart is described.

Step S41: Determine whether or not there is an unprocessed key. Proceed to Step S42 if there is the unprocessed key, and terminate the processing if there is no unprocessed key.

Step S42: Acquire attribute information of a key to be processed.

Step S43: Determine whether or not the “isVariable” attribute is “true”. Proceed to Step S44 if the “isVariable” attribute is “true”, and return to Step S41 if the “isVariable” attribute is not “true”.

Step S44: Determine whether or not the left key is omitted. Proceed to Step S45 if the left key is omitted, and proceed to Step S49 if the left key is not omitted.

Step S45: Determine whether or not the “isVariable” attribute of the further left key is “true”. Proceed to Step S46 if the “isVariable” attribute of the further left key is “true”, and proceed to Step S48 if the “isVariable” attribute of the further left key is not “true”.

Step S46: Adjust correction of the further left key.

Step S47: Correct by extending to the left by 0.5 key.

Step S48: Correct by extending to the left by one key.

Step S49: Determine whether or not the right key is omitted. Proceed to Step S50 if the right key is omitted, and return to Step S41 if the right key is not omitted.

Step S50: Correct by extending to the right by one key, and then return to Step S41.

As described above, in this embodiment, when a gap is generated between the keys on the software keyboard according to the first embodiment, the keys adjacent to the gap are enlarged and displayed. Accordingly, the correction is performed such that specific keys are enlarged and displayed, in addition to the effects achieved by the first embodiment. Thus, such correction makes it easier for the user to press the specific keys. As a result, the convenience for the user can be further improved.

Note that, although the description is given of the case where layout information correction unit 26 corrects the layout information before a display of the software keyboard in this embodiment, the invention is not limited thereto. For example, during Japanese entry in Roman letters, vowel keys may be corrected and displayed after consonant keys are entered. Furthermore, layout information correction unit 26 may correct all the keys on the software keyboard or may correct specific keys only.

Moreover, although the description is given of the case where the keys are laterally enlarged in this embodiment, the invention is not limited thereto. Instead, the keys may be enlarged to be highlighted. Furthermore, the keys on the software keyboard may be increased or reduced in size according to the dimensions of operation panel unit 21, i.e., the layout information may be corrected. For example, during Japanese entry in Roman letters, consonant keys may be displayed in a smaller size and vowel keys may be displayed in a larger size.

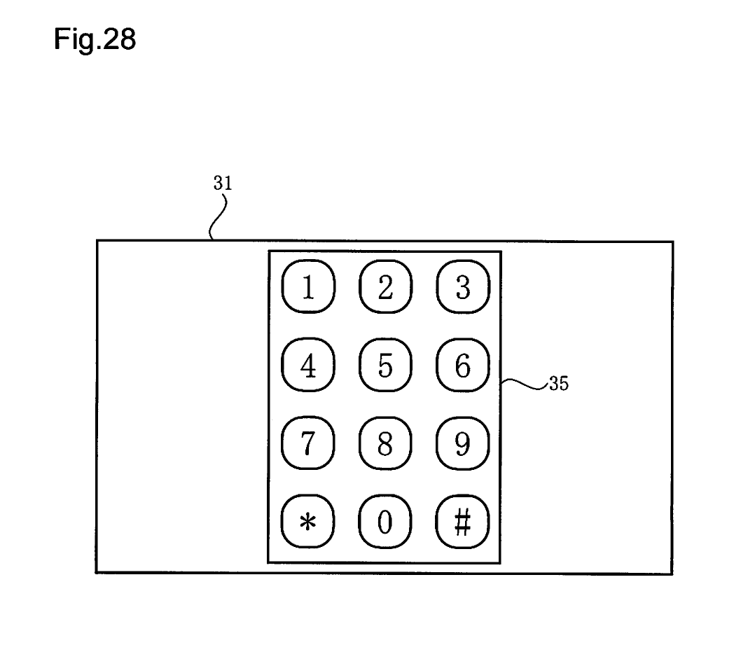

For example, in this embodiment, only the enlarged numerical keypad section 35 may be displayed on touch panel section 31 as illustrated in FIG. 28.

Note that the first and second embodiments are not to display a candidate to be entered next.

Moreover, although the description is given of the case where the image processing apparatus is multifunction machine 10 in the first and second embodiments, the invention is not limited thereto. The image processing apparatus may be any kind of apparatus as long as the apparatus executes image data processing, such as a printer, a fax machine, a copying machine and a scanner.

Furthermore, although the description is given of the example where operation panel unit 21 is used as the input device included in multifunction machine 10 as the image processing apparatus, the invention is not limited thereto. The input device may be any kind of device as long as the device includes a touch panel such as a mobile terminal and can perform an input operation by displaying a software keyboard.

This invention is not limited to the above embodiments, but various modifications can be made based on the spirit of the present invention. It is accordingly not intended that such modifications are excluded from the scope of the invention.

The invention can be applied to an input device and an image processing apparatus.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An input device configured to display a software keyboard drawn by software and receive an input from a user, comprising:
a touch panel unit configured to perform as a display to the user and receive an input by contact from the user, with the software keyboard being displayed on the touch panel unit;
a layout information storage unit configured to store, as layout information, information about layout modes of keys included in the software keyboard and display modes of the keys;
a condition acceptance unit configured to accept a condition for selecting the layout information; and
a software keyboard display instruction unit configured to read layout information that maintains the key layout mode while changing the display mode of some of the keys according to the condition, and to instruct the touch panel unit to display a software keyboard based on the read layout information.

2. The input device according to claim 1, wherein
the software keyboard display instruction unit is configured to instruct the touch panel unit to display a software keyboard with the display mode of some of the keys changed by a disablement of a pressing of unnecessary keys.

3. The input device according to claim 1, wherein
the software keyboard display instruction unit is configured to instruct the touch panel unit to display a software keyboard with the display mode of some of the keys changed by a disablement of a pressing of unnecessary keys and extending adjacent keys into a gap generated by the disablement.

4. The input device according to claim 2, wherein
the software keyboard display instruction unit disables pressing of the unnecessary keys by deleting or graying out the unnecessary keys.

5. The input device according to claim 1, further comprising:
a layout information correction unit configured to correct the layout information read from the layout information storage unit by the software keyboard display instruction unit.

6. The input device according to claim 5, wherein
the layout information correction unit is adapted to correct all the keys included in the software keyboard.

7. The input device according to claim 5, wherein
the layout information correction unit is adapted to correct specific keys included in the software keyboard.

8. The input device according to claim 5, wherein
the layout information includes information about whether or not correction by the layout information correction unit is possible, and
the layout information correction unit is configured to determine keys to be corrected based on the information about whether or not the correction of the keys included in the software keyboard is possible.

9. The input device according to claim 5, wherein
the layout information correction unit corrects the layout information based on dimensions of the touch panel unit.

10. The input device according to claim 5, wherein
the layout information correction unit corrects the layout information based on whether or not adjacent keys are deleted.

11. The input device according to claim 1, wherein
the condition acceptance unit accepts type information of a unit configured to receive an input from the software keyboard as the condition.

12. The input device according to claim 2, wherein
the layout information includes unnecessary key information as information on the unnecessary keys, and
the condition acceptance unit accepts the unnecessary key information.

13. The input device according to claim 1, wherein
the layout information includes control key information, and
the condition acceptance unit is configured to accept the control key information.

14. An image processing apparatus comprising:
the input device according to claim 1;
an image processing unit configured to generate an image; and
a control unit configured to control the image processing unit and transmit a condition to the condition acceptance unit.

15. The image processing apparatus according to claim 14, wherein
the condition acceptance unit is configured to accept a use situation from the control unit as the condition.

16. The image processing apparatus according to claim 14, wherein
the condition acceptance unit is configured to accept language information set for the image processing apparatus as the condition.
